(19) United States
(12) Patent Application Publication
(10) Pub. No.: US 2007/0177530 A1
(43) Pub. Date: Aug. 2, 2007

(54) Large-scale wide area network system having location information management function

(75) Inventors: Tatsuhiro Ando, Kawasaki (JP); Yoshihiro Kubota, Kawasaki (JP); Hidehiko Suzuki, Kawasaki (JP); Takuji Oyama, Kawasaki (JP)

Correspondence Address: BINGHAM MCCUTCHEN LLP, 2020 K Street, N.W., Intellectual Property Department, WASHINGTON, DC, 20006, US

(73) Assignee: Fujitsu Limited

(21) Appl. No.: 11/439,210

(22) Filed: May 24, 2006

(30) Foreign Application Priority Data
Feb. 1, 2006 (JP) 2006-024278

(51) Int. Cl. H04B 7/00

(52) U.S. Cl. 370/277; 370/328

(57) ABSTRACT

A large-scale wide area network system includes wireless communication base devices respectively configuring access points covering wireless zones subordinate thereto; wireless communication base control devices performing integrated control of the corresponding wireless communication base devices, and managing IP addresses of the wireless communication base control devices of a home location and a visited location as location information of a mobile terminal; in-area location information management devices respectively connected to the corresponding wireless communication base control devices via respective area IP networks corresponding to areas administered by the same common carrier, and managing the IP address of the wireless communication base control device of the home location as the location information of the mobile terminal; and a wide area location information management device hierarchically connected to the in-area location information management devices via a wide area IP network corresponding to a wide area administered by the common carrier, and managing the IP address of the corresponding in-area location information management device as the location information of the mobile terminal.

### BACKGROUND OF THE INVENTION

The present invention relates to a large-scale wide area network system having a location information management function for enabling a mobile terminal to move between wireless zones.

In a wireless LAN (WLAN: Wireless Local Area Network) technology at the present, when the mobile terminal moves (visits) to a wireless zone (a wireless LAN zone or a service area) subordinate to a new wireless access point (AP) during a mobile talk, if within the same subnet of a wired LAN, handover can take place without disconnecting the mobile talk (seamlessly) between the wireless LAN access points AP. Further, also between different subnets, the handover of the mobile terminal can take place without disconnecting the mobile talk by linking up wireless LAN controllers with each other that connect the respective wireless LAN access points AP.

As shown in FIG. 1, the prior art is that in a communication network system having an IP (Internet Protocol) network (in-enterprise IP network) that connects a plurality of wireless LAN systems, when a user moves during the mobile talk by use of a mobile terminal such as an IP cell phone terminal and a PDA (Personal Digital Assistant), the handover can be done while keeping the mobile talk connected only in such a case that the wireless LAN access point AP controlling the wireless zone of a visited location exists in the same subnet of the wired LAN, or only within an extremely limited range in which several wireless LAN controllers (which are herein wireless LAN switches) are capable of controlling.

Accordingly, a scheme of applying the conventional communication network system to the large-scale wide area network must involve managing the location information by linking up a multiplicity of mobile terminals with each other through a multiplicity of wireless LAN controllers, requires a tremendous quantity of data processing, takes a considerable load and is therefore unrealistic.

Normally, basically if within the same subnet, a communication area is limited to one floor or a partial area within the floor of an office building. Further, even in a range that can be covered by the several wireless LAN controllers, the communication area is limited to a closed network within a single enterprise, and a scheme applied to the large-scale wide area network at a nationwide level such as a common carrier network is in fact impossible.

The following is a related art to the present invention. [Patent document 1] Japanese Patent Laid-Open Publication No. 2005-124060

### SUMMARY OF THE INVENTION

It is an object of the present invention to provide a technology enabling a scheme to attain more of efficiency for managing the location information of the mobile terminal in the large-scale wide area network system.

It is another object of the present invention to provide a technology capable of strengthening security in the case of providing communications to the mobile terminal by linking up with IP networks of other common carriers.

It is still another object of the present invention to provide a technology capable of supporting an application utilizing the location information such as an emergency call service etc.

For solving the problems, according to the present invention, a large-scale wide area network system having a location information management function for enabling a mobile terminal to move between wireless zones, comprises: a plurality of wireless communication base devices respectively configuring a plurality of access points covering the wireless zones subordinate thereto; a plurality of wireless communication base control devices performing integrated control of the plurality of corresponding wireless communication base devices, and managing IP addresses of the wireless communication base control devices of a home location and a visited location as location information of the mobile terminal; a plurality of in-area location information management devices respectively connected to the plurality of corresponding wireless communication base control devices via respective area IP networks corresponding to areas administered by the same common carrier, and managing the IP address of the wireless communication base control device of the home location as the location information of the mobile terminal; and a wide area location information management device hierarchically connected to the plurality of in-area location information management devices via a wide area IP network corresponding to a wide area administered by the common carrier, and managing the IP address of the corresponding in-area location information management device as the location information of the mobile terminal.

The large-scale wide area network system according to The present invention further comprises a response device sending back, as a response, only existing-in-zone information showing that the mobile terminal exists in a zone under control of a self common carrier IP network administered by the self common carrier in response to a query about the location information of the mobile terminal from one other common carrier if necessary for linking up, about the location information of the mobile terminal, with the other common carrier IP network administered by the other common carrier different from the self common carrier.

The large-scale wide area network system according to The present invention further comprises a response device sending back, in response to a query about the location information from an application utilizing the location information of the mobile terminal, the location information of the mobile terminal as a response that has been acquired by the wireless communication base control device, the in-area location information management device and the wide area location information management device in linkage with each other.

In the configurations described above, each of the plurality of wireless communication base devices manages a terminal MAC address and a terminal IP address as the location information of the mobile terminal. Further, each of the plurality of wireless communication base control devices further manages the terminal MAC address, the terminal IP address and an IP address of the wireless communication base device covering the present location as the location information of the mobile terminal.

According to the present invention, the location information management device also manages the location information managed by the wireless communication base control device such as a wireless LAN controller, and further the location information management devices are hierarchized corresponding to a scale of the network (IP network). Moreover, the detailed location information is managed by the lower-order location information management device, while the higher-order location information management device manages not the detailed information but rough location information. With this scheme, it is possible to restrain a data size and an update frequency of the data managed by the higher-order location information management device and to thus attain more of efficiency for managing the location information.

Further, in consideration of a case that the mobile terminal moves across the wireless zone (handover, roaming), an influence range is limited to the wireless communication base control device or the lower-order location information management device to the greatest possible degree so as not to exert influence (management load) of the present location information of the mobile terminal up to the higher-order location information management device each time the mobile terminal moves across the wireless communication base device serving as an access point. This scheme can flexibly support the small-scale through large-scale networks.

Still further, in the case of providing the communications to the mobile terminal by linking up with one other common carrier IP network, the security can be strengthened by replying a piece of existing-in-zone information showing only whether the mobile terminal accesses under control of the self common carrier IP network in response to a location information query from the side of the other common carrier IP network, and by restricting information disclosure to the other common carrier IP network by concealing the detailed location information.

Yet further, so as to support an application utilizing the location information such as an emergency call service as in the case of Dial “110” and Dial “119”, the present location of the mobile terminal can be specified as a location of the wireless communication base device by linking up the wireless communication control device, the in-area location information management device and the wide-area location information management device with each other.

Other objects, features and advantages of the present invention will become apparent by reading one embodiment that will hereinafter be described when taken in conjunction with the drawings and Scope of Claims appended.

### BRIEF DESCRIPTION OF THE DRAWINGS

FIG. 1 is a block diagram showing an architecture of a conventional communication network system;

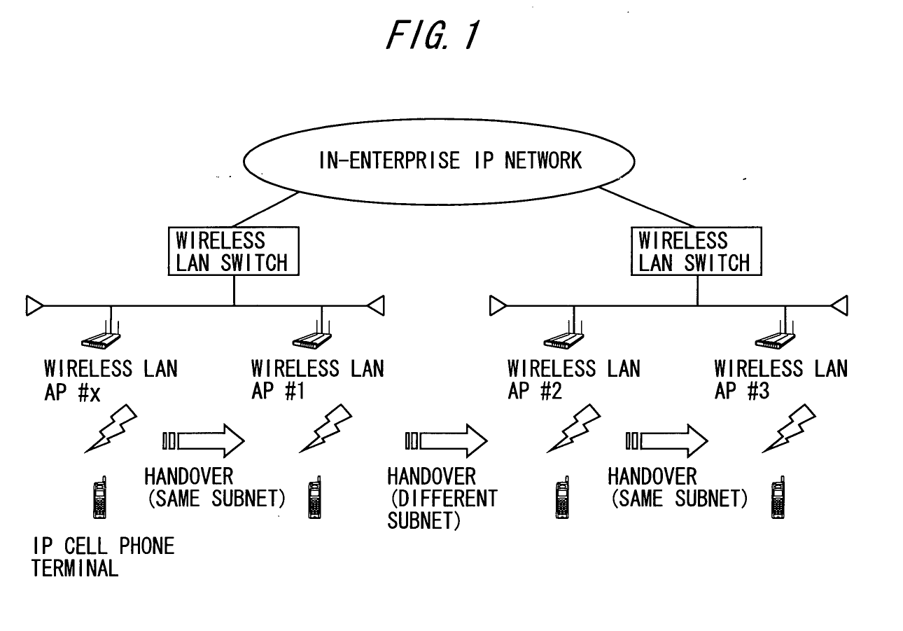

FIG. 2 is a block diagram showing an architecture of a communication network system in a first embodiment of the present invention;

FIG. 3 is a block diagram showing a detailed configuration of a wireless LAN controller;

FIG. 4 is a block diagram showing detailed configurations of an in-area location information management server and an inter-wide-area location information management server;

FIG. 5 is a diagram showing an example of a structure of a location information management table in the wireless LAN controller;

FIG. 6 is a diagram showing an example of a structure of the location information management table in the in-area location information management server;

FIG. 7 is a diagram showing an example of a structure of the location information management table in the inter-wide-area location information management server;

FIG. 8 is an explanatory diagram showing an operational example in the communication network system in the first embodiment;

FIG. 9 is an explanatory diagram showing an operational example in the communication network system in the first embodiment;

FIG. 10 is an explanatory diagram showing an operational example in the communication network system in the first embodiment;

FIG. 11 is an explanatory diagram showing an operational example in the communication network system in the first embodiment;

FIG. 12 is an explanatory diagram showing an operational example in the communication network system in the first embodiment;

FIG. 13 is an explanatory diagram showing an operational example in the communication network system in the first embodiment;

FIG. 14 is an explanatory diagram showing an operational example in the communication network system in the first embodiment;

FIG. 15 is an explanatory diagram showing an operational example in the communication network system in the first embodiment;

FIG. 16 is a block diagram showing an architecture of the communication network system in a second embodiment of the present invention;

FIG. 17 is an explanatory diagram showing an operational example in the communication network system in the second embodiment;

FIG. 18 is a block diagram showing an architecture of the communication network system in a third embodiment of the present invention; and

FIG. 19 is an explanatory diagram showing an operational example in the communication network system in the third embodiment.

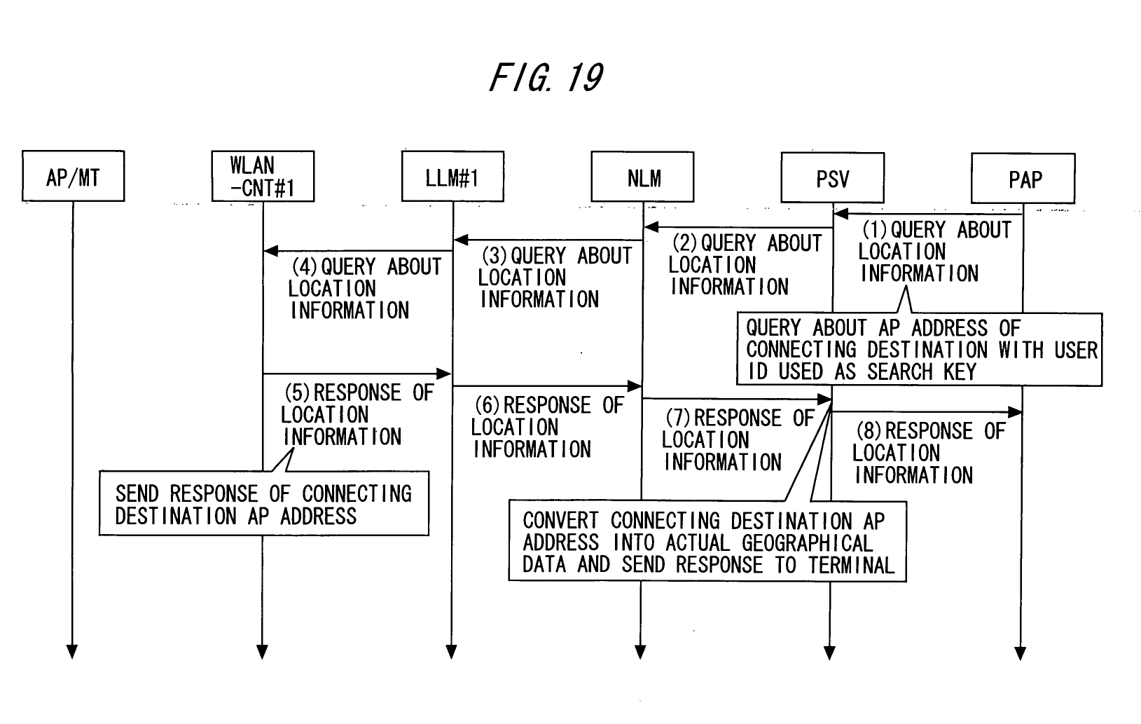

### DETAILED DESCRIPTION OF THE PREFERRED EMBODIMENTS

The present invention will hereinafter be described in greater detail with reference to the accompanying drawings. The drawings illustrate preferred embodiments of the present invention. The present invention can be, however, carried out in many different modes and should not be construed to be limited to the embodiments described in the specification. More essentially, these embodiments are provided so that the disclosure of the specification becomes thorough and perfect, and so that the scope of the present invention is sufficiently conveyed to those skilled in the art.

### First Embodiment

### Example of Architecture of Communication Network System

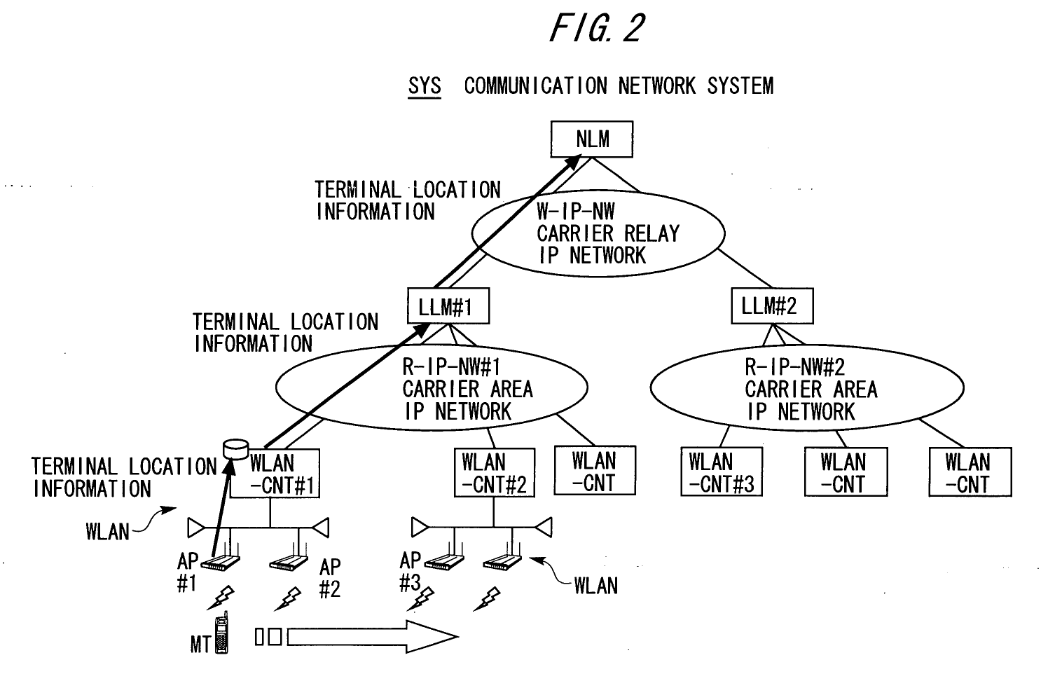

Architecture of a communication network system in a first embodiment of the present invention will be explained. Referring to FIG. 2, the communication network system SYS configures a large scale/wide area network system having a location information management function for mobile terminals MT such as IP (Internet Protocol) cell phone terminals and PDAs (Personal Digital Assistants) that utilize a Wireless LAN (Local Area Network) system WLAN.

In each wireless LAN system WLAN, a plurality of access points (wireless communication base devices) AP is theoretically cascade-connected to a wired network configured by a wired LAN.

A wireless zone (a wireless LAN zone or a service area) subordinate to each access point AP uses different wireless channels (wireless lines). Accordingly, each access point AP and each mobile terminal (which might be simply termed a terminal) MT operate (communicate) by radio frequency signals assigned to the access point AP and the terminal MT, respectively.

Each wireless LAN system WLAN includes a wireless LAN controller WLAN-CNT (WLAN Controller) and a DHCP (Dynamic Host Configuration Protocol) server DSV (of which an illustration is omitted) each connected to the wired LAN. Only the single DHCP server DSV can be also provided for the plurality of wireless LAN systems WLAN.

The wireless LAN controller WLAN-CNT of each wireless LAN system WLAN is connected to carrier area IP networks R-IP-NW (#1, #2) that cover the areas and are administered by the same carrier (the common carrier or simply the carrier). Herein, the two carrier area IP networks R-IP-NW exist in geographically (locally) different areas such as the Kanto region or the Kansai region or the largest administrative units of Japanese local government. Each carrier area IP network R-IP-NW has in-area location information management servers (Local Location Managers) LLM (#1, #2).

The two carrier area IP networks R-IP-NW and the two in-area location information management servers LLM are connected to a carrier relay IP network (wide area IP network) W-IP-NW. The carrier relay IP network W-IP-NW has an inter-wide-area location information management server (Network Wide Location Manager) NLM.

### Example of Configurations of Wireless LAN Controller and of Location Information Management Server

One feature of the communication network system SYS in the first embodiment of The present invention shown in FIG. 2 is that the location information management servers are hierarchized within the area and between the wide areas, and are disposed as the in-area location information management servers LLM and the inter-wide-area location information management server NLM. Then, these control devices (controllers) including the wireless LAN controllers WLAN-CNT share functions as follows. To be specific, each wireless LAN controller WLAN-CNT manages home location information and visited location information of the mobile terminal MT. Each of the in-area location information management servers LLM manages detailed location information of the mobile terminal MT. Further, the inter-wide-area location information management server NLM manages rough location information of the mobile terminal MT.

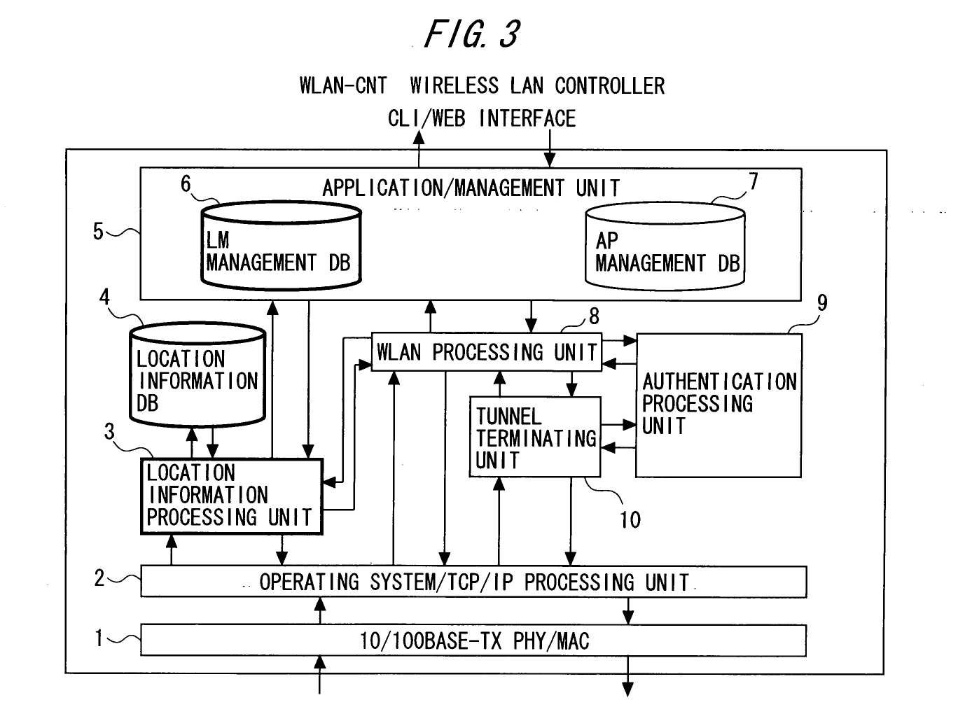

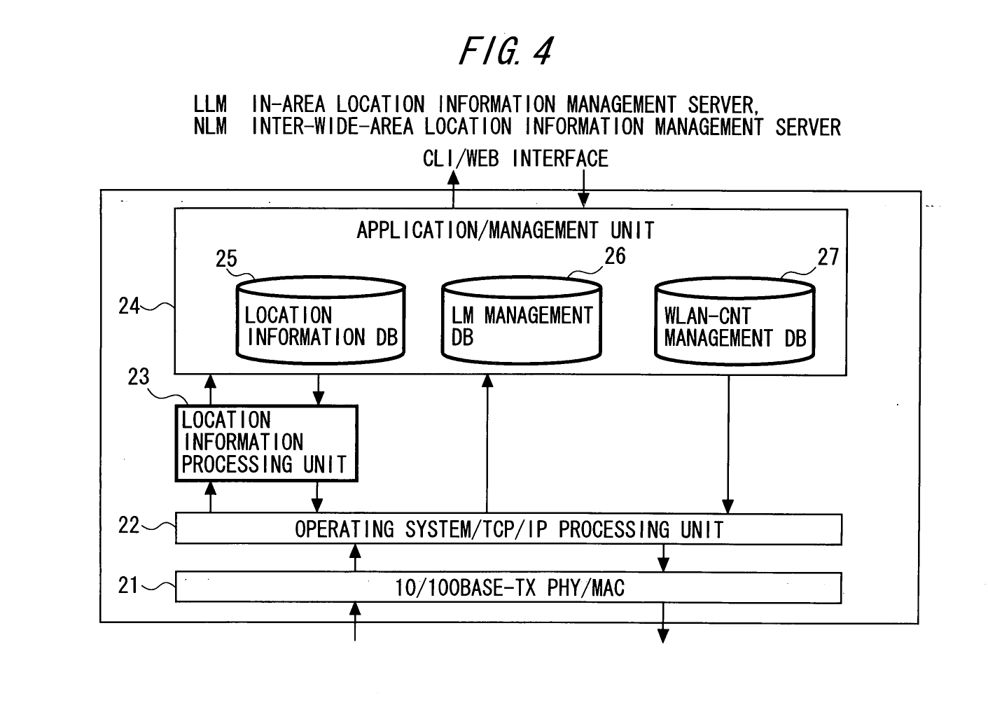

FIGS. 3 and 4 show examples (function block diagrams) of configurations of the wireless LAN controller WLAN-CNT, the in-area location information management server LLM and the inter-wide-area location information management server NLM, which serve to manage the location information of the mobile terminal MT.

The wireless LAN controller WLAN-CNT serving as the wireless communication base control device is a device that controls and manages the plurality of access points AP and performs integrated control of wireless LAN control between the mobile terminals MT in a way that conducts tunneling (establishing a tunnel connection) between the access points AP.

As shown in FIG. 3, the wireless LAN controller WLAN-CNT includes, as main components, other than a user data packet transmission/reception processing function, a location information processing unit 3 for executing a transmitting/receiving process and a control process of the location information, a location information database (DB) 4 for managing the location information, and an LM management DB 6 for managing registration information of the in-area location information management server LLM and the inter-wide-area location information management server NLM.

Further, as illustrated in FIG. 4, each of the in-area location information management server LLM and the inter-wide-area location information management server NLM includes, as main components, a location information processing unit 23 for transmitting and receiving the location information to and from the wireless LAN controller WLAN-CNT or the location information management servers of other hierarchies, a location information DB 25 for managing the location information, an LM management DB 26 for managing the registration information of the in-area location information management server LLM and the inter-wide-area location information management server NLM, and a WLAN-CNT management DB 27 for managing the registration information of the wireless LAN controller WLAN-CNT.

To give an in-depth description, the wireless LAN controller WLAN-CNT further includes a 10/100 Base-TX PHY/MAC 1, an Operating System/TCP/IP processing unit 2, an application/management unit 5, an AP management DB 7, a WLAN processing unit 8, an authentication processing unit 9 and a tunnel terminating unit 10. The application/management unit 5 is connected via a CLI (Command Line Interface) /Web interface to a terminal of a maintenance administrator.

Moreover, each of the in-area location information management server LLM and the inter-wide-area location information management server NLM further includes, a 10/100 Base-TX PHY/MAC 21, an Operating System/TCP/IP processing unit 22 and an application/management unit 24. The application/management unit 24 is connected via the CLI/Web interface to the terminal of the maintenance administrator.

In the wireless LAN controller WLAN-CNT, the in-area location information management server LLM and the inter-wide-area location information management server NLM, each of the 10/100 Base-TX PHY/MACs 1 and 21 executes controlling the physical layer/MAC layer with respect to the transmission and reception of an Ethernet (registered trademark) frame, and is constructed of a general-purpose chip. Each of the Operating System/TCP/IP processing units 2 and 22 controls TCP/IP basic functions implemented by standard into OS components and the OS such as Windows (registered trademark) and LINUX (registered trademark). Each of the location information processing units 3 and 23 executes processes such as registering the location information of the mobile terminal MT, and making a query and a response about the location information thereof. Each of the location information DBs 4 and 25 is a database for retaining the location information of the mobile terminal MT.

Further, each of the application/management units 5 and 24 executes applications (radio wave control etc) other than the location information control that operate on the wireless LAN controller WLAN-CNT, and executes device management functions (such as setting a device parameter and updating firmware). Each of the LM management DBs 6 and 26 is a database for retaining addresses of the visited location information management servers. The AP management DB 7 is a database for retaining the setting data of the access points AP connected to the wireless LAN controller WLAN-CNT.

Moreover, the WLAN processing unit 8 establishes a connection between the access point AP and the mobile terminal MT, and executes an authentication process. The authentication processing unit 9 is a database for retaining an address translation table. The tunnel terminating unit 10 executes a process of establishing and disconnecting the tunnel for transmitting and receiving the user data packet and a control packet between the wireless LAN controller WLAN-CNT and the access point AP and between the other wireless LAN controllers WLAN-CNT. The WLAN-CNT management DB 27 is a database for retaining an address of the subordinate wireless LAN controller WLAN-CNT.

### Example of Structure of Location Information Management Table

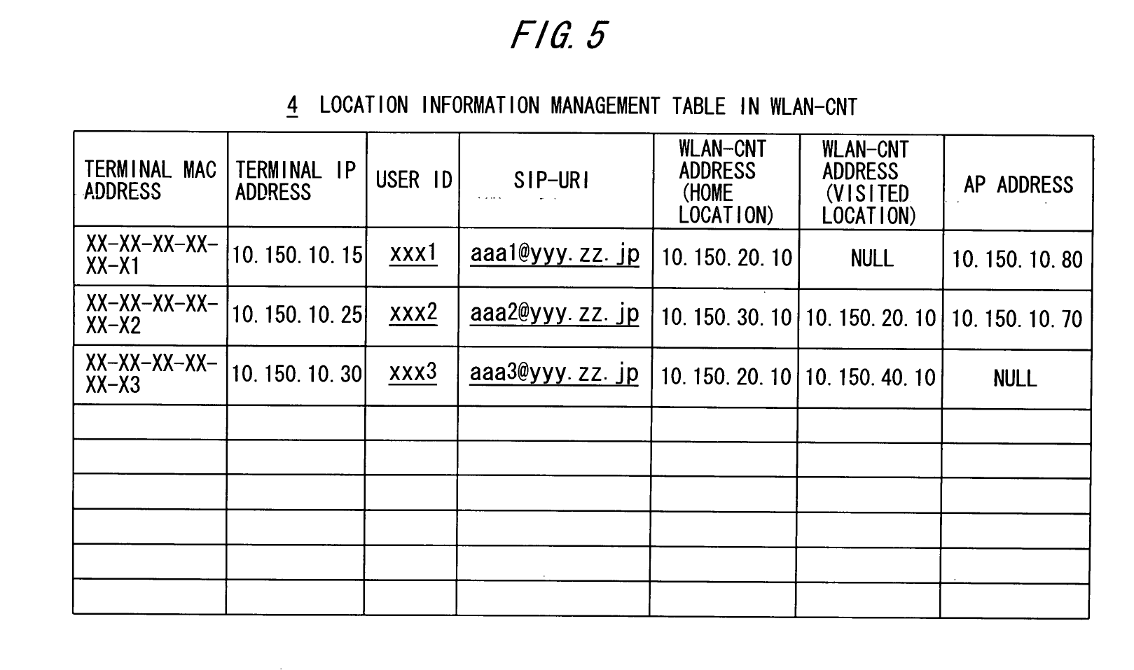

FIGS. 5, 6 and 7 show examples of the location information management tables 4 and 25 in the wireless LAN controller WLAN-CNT, the in-area location information management server LLM and the inter-wide-area location information management server NLM.

(1) Location Information in WLAN-CNT

The wireless LAN controller WLAN-CNT manages, in the location information management table (location information DB) 4, terminal MAC addresses, terminal IP addresses, WLAN-CNT addresses (a home location address and a visited location address), AP addresses, user IDs and an SIP-URI (Session Initiation Protocol-Uniform Resource Identifier). The wireless LAN controller WLAN-CNT manages the WLAN-CNT addresses (IP addresses) of the home location and the visited location as well as managing the IP address of the access point AP that covers the present location so as to support a case of handover occurred not only between the access points AP but also between the wireless LAN controllers WLAN-CNT when the user moves during a mobile talk (communications).

(1-1) Location Information at Startup Time of Terminal

Generally, when starting up (power-on) the wireless LAN terminal (mobile terminal) MT, an access to the wireless LAN controller WLAN-CNT via the access point AP in the wireless LAN system WLAN is made, and wireless LAN authentication is completed. Thereafter, the DHCP server DSV leases out (address lease) an IP address, whereby the mobile terminal MT can perform the communications. In the location information management table 4 of the wireless LAN controller WLAN-CNT, items of location information of the mobile terminal MT are managed as the terminal IP address, the WLAN-CNT IP address (home location address), the AP IP address, the user ID and the SIP-URI in the way of their being associated with the MAC address, defined as key information, of the mobile terminal MT.

In the communication network system SYS of The present invention, these items of information are managed by the LM servers LLM and NLM as well as being managed by the wireless LAN controller WLAN-CNT. The wireless LAN controller WLAN-CNT registers the location information registered when starting up of the terminal in the in-area location information management server LLM serving as the in-area LM server. Furthermore, the in-area location information management server LLM registers the location information in the inter-wide-area location information management server NLM serving as the LM server for the whole network. It is to be noted that the access point AP stores and thus manages the MAC address and the terminal IP address of the mobile terminal MT.

(1-2) Location Information at Handover Time of Terminal (Location Information in WLAN-CNT as Handover Destination)

When there occurs the handover of the terminal MT to the self wireless LAN controller WLAN-CNT (self WLAN-CNT) from one other wireless LAN controller WLAN-CNT (other WLAN-CNT), in the location information in the self WLAN-CNT, as in the second-row data elements (the second-row record) in the location information management table 4 shown in FIG. 5, not only the IP address of the other WLAN-CNT that is defined as the home location (address) but also the IP address of the self WLAN-CNT are registered.

(1-3) Location Information at Handover Time of Terminal (Location Information in WLAN-CNT as Handover Source)

When there occurs the handover of the terminal MT to the other wireless LAN controller WLAN-CNT from the self wireless LAN controller WLAN-CNT, in the location information in the self WLAN-CNT, as in the third-row data elements (the third-row record) in the location information management table 4 shown in FIG. 5, the IP address of the self WLAN-CNT that is defined as the home location (address) but also the IP address of the other WLAN-CNT that is defined as the visited location (address) are registered. Further, a transfer of the packet from the other WLAN-CNT to the connection access point AP is processed by the other WLAN-CNT defined as the visited location, and hence the address information of the access point AP is unnecessary (Null)

(2) Location Information In LLM

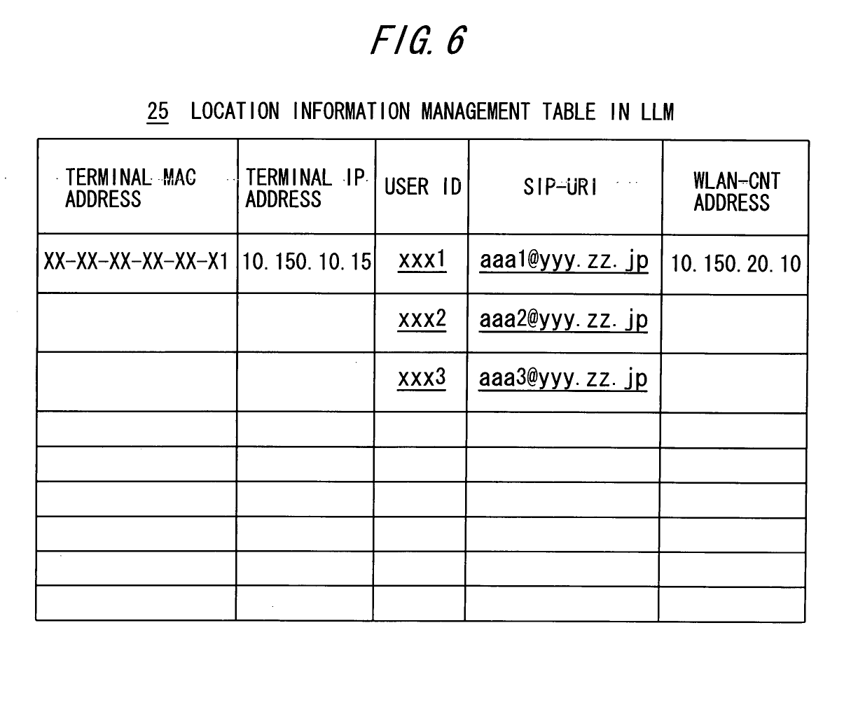

In the location information management table 25 of the in-area location information management server LLM, as shown in FIG. 6, among the items (entries) of location information registered in the wireless LAN controller WLAN-CNT when starting up the terminal, the terminal IP address, the WLAN-CNT address, the user ID and the SIP-URI are managed in the way of being associated with the terminal MAC address serving as the key information. In this location information management table 25, only the IP address of the home WLAN-CNT is managed as the WLAN-CNT address.

(3) Location Information in NLM

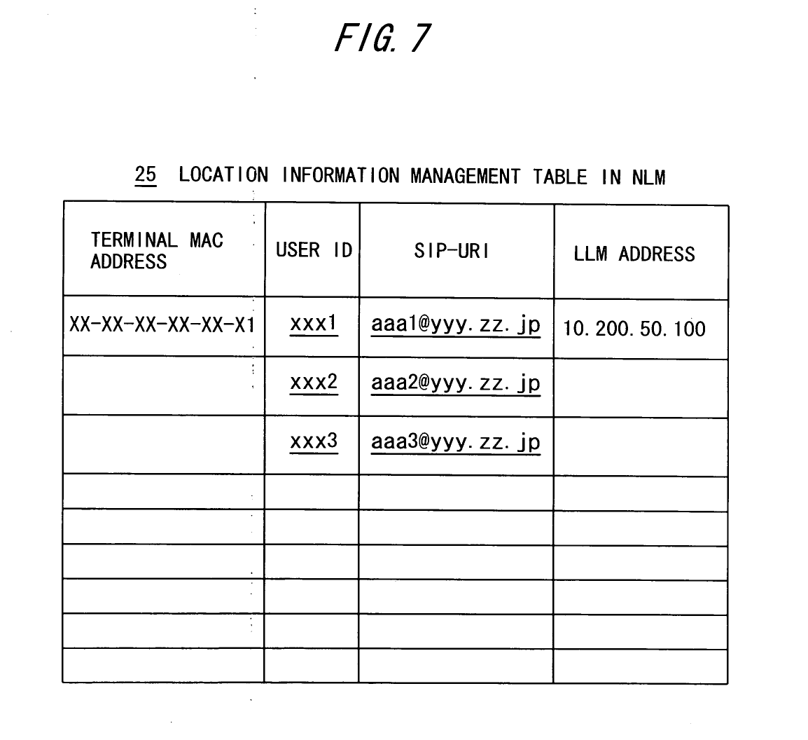

In the location information management table 25 of the inter-wide-area location information management server NLM, as shown in FIG. 7, among the items of location information registered in the location information management table 25 of the in-area location information management server LLM, the user ID, the SIP-URI and the LLM address (IP address) are managed in the way of being associated with the terminal MAC address serving as the key information.

### Operational Example of Communication Network System

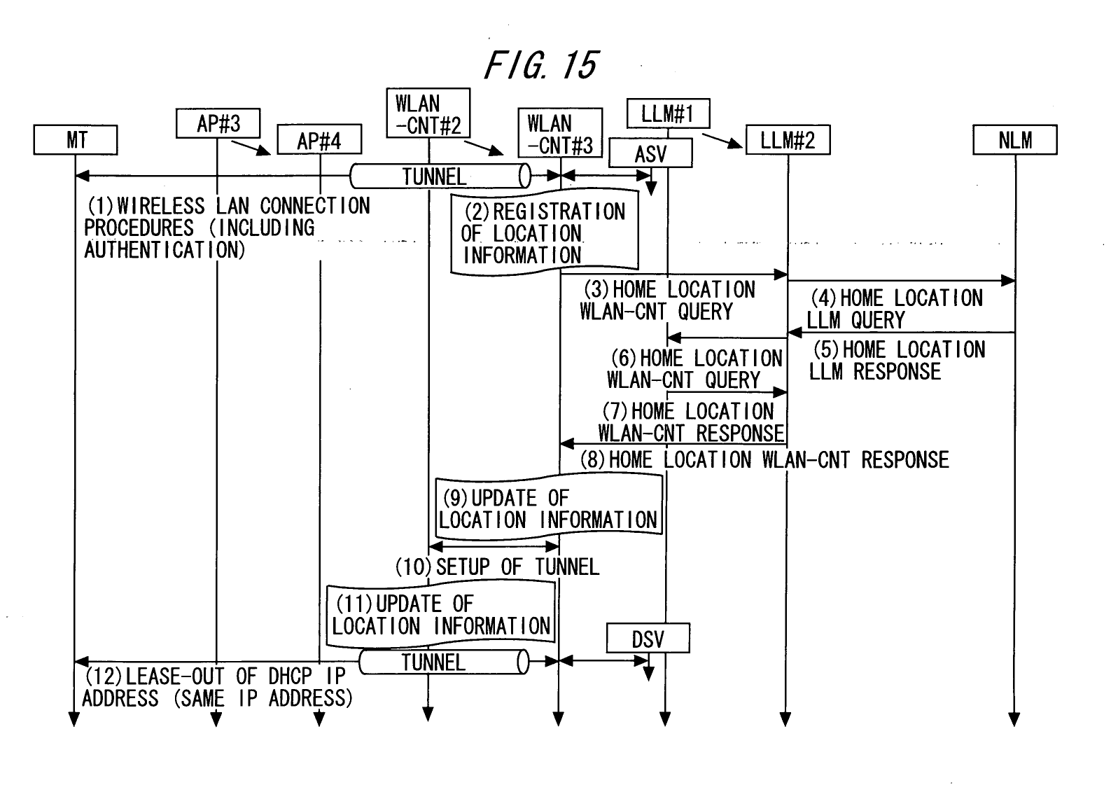

Next, an operational example in the communication network system SYS in the first embodiment of The present invention shown in FIG. 2, will be explained with reference to FIGS. 3 through 15 in combination. Note that bracketed numerals represent procedure numbers of the processes throughout these drawings for illustrating the operational example.

### Operation A: Location Information Registering Procedure at Terminal Startup Time

In the communication network system SYS in the first embodiment of The present invention, the location information of the mobile terminal MT is registered in not only the wireless LAN controller WLAN-CNT but also the in-area location information management server LLM and the inter-wide-area location information management server NLM, and is then employed.

In this communication network system SYS, a premise is that tunneling (IPsec (IP Security; Security Architecture of Internet Protocol), GRE (Generic Route encapsulation) tunneling, etc) is set between the access point AP of the wireless LAN system WLAN and the wireless LAN controller WLAN-CNT, wherein various categories of data are encapsulated and thus transmitted and received via the wired LAN.

Process 1: Wireless LAN Connecting Procedure (including user authentication)

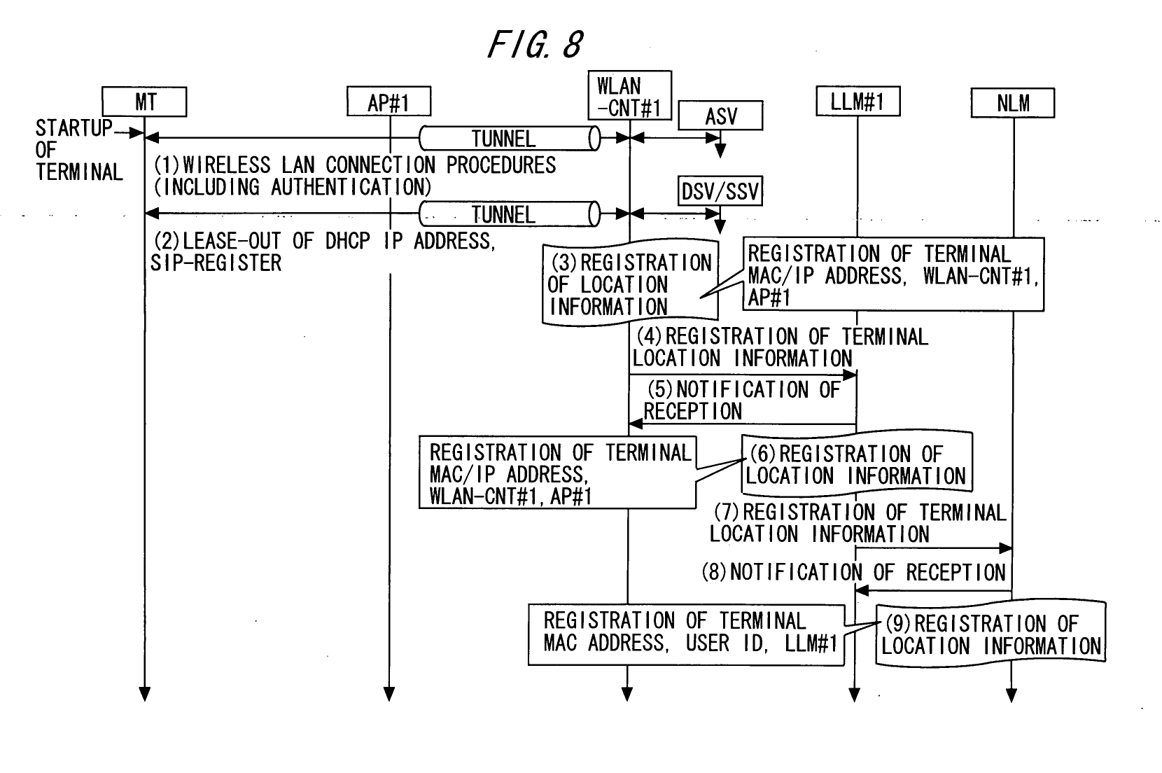

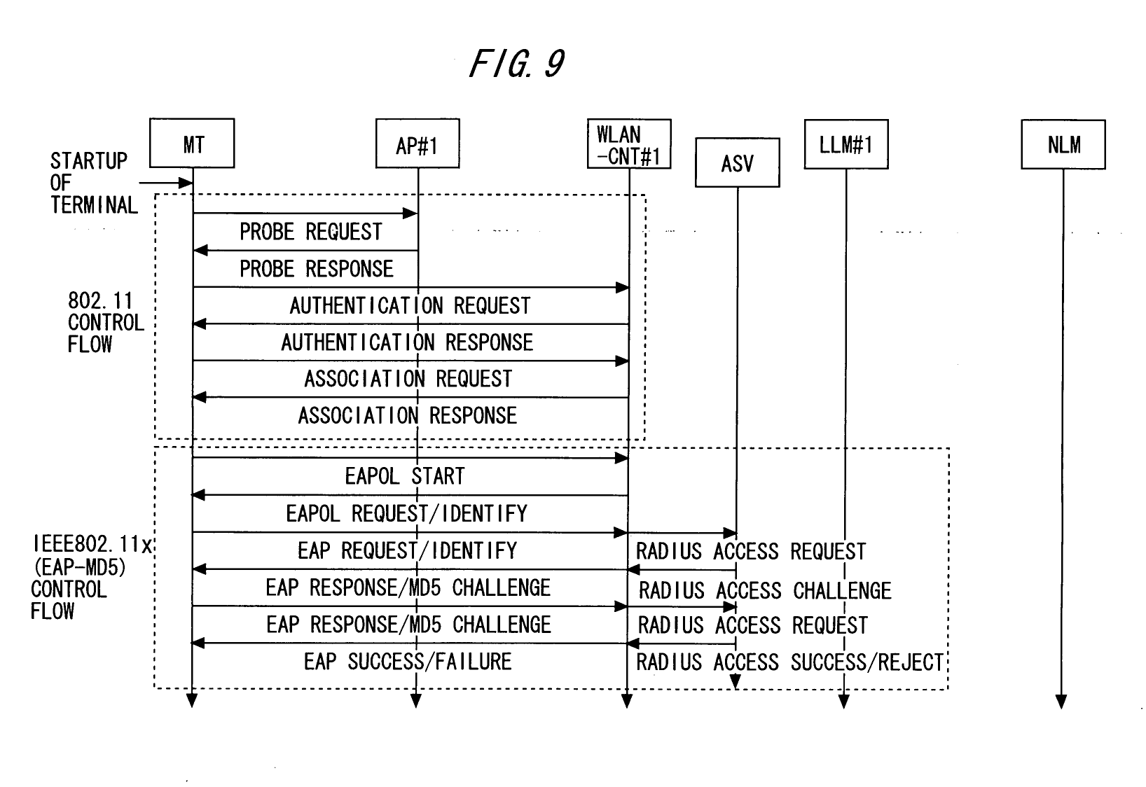

Referring to FIG. 8, the mobile terminal MT utilized by the user, for performing the communications, after being started up (after the power-on), must connect to the access point AP of the wireless LAN system WLAN according to the procedures of IEEE (Institute of Electrical and Electronics Engineers) 802.11. On the occasion of accessing the wireless LAN system WLAN, the user is authenticated (see FIG. 9 for more details) in order to check whether the user is authorized for accessing or not.

(1-1) IEEE802.11 control Flow (Connecting Process between Terminal MT and Wireless LAN system WLAN)

A wireless LAN authentication request message and a wireless LAN connection request message such as Authentication Request/Response and Association Request/Response, are received by the access point AP (#1) and, after being encapsulated, transferred to the wireless LAN controller WLAN-CNT (#1).

As shown in FIG. 3, in the wireless LAN controller WLAN-CNT, the encapsulated packet is, after being received by the 10/100 Base-TX PHY/MAC 1, transferred to the Operating System/TCP/IP processing unit 2. The Operating System/TCP/IP processing unit 2, for decapsulating the encapsulated packet, judges based on header information that the packet is the encapsulated packet, and transfers the packet to the tunnel terminating unit 10.

The tunnel terminating unit 10, after the decapsulation of the packet, extracts an 802.11 frame and transfers the frame to the WLAN processing unit 8. The WLAN processing unit 8 executes a process of giving a response to the terminal MT in response to the wireless LAN authentication request/connection request messages.

(1-2) IEEE802.11x (EAP-MD5) Control Flow (User Authentication Process)

With respect to the user authentication process, the WLAN processing unit 8 receives each EAP (Extensible Authentication Protocol) message from the terminal MT. The wireless LAN controller WLAN-CNT, in the case of sending an authentication request to the authentication server ASV accommodated in the carrier area IP network R-IP-NW or the carrier relay IP network W-IP-NW, transmits and receives an access request message and an access challenge message by use of RADIUS (Remote Authentication Dial-In User Service) protocol via the authentication processing unit 9, thus conducting the user authentication.

(1-3) Registration of User Authentication Information

The wireless LAN controller WLAN-CNT, when in the user authentication process, acquires user authentication information such as the terminal MAC address and the user ID from the authentication server ASV, and registers the user authentication information together with the IP address of the connecting destination access point AP in the location information management table (location information DB) 4.

The authentication processing unit 9, after acquiring the terminal MAC address, the user ID and the SIP-URI, transfers these items of information to the WLAN processing unit 8. The WLAN processing unit 8 transfers reception information together with the IP address of the connecting destination access point AP to the location information processing unit 3. The location information processing unit 3 registers the reception information and the WLAN-CNT address together in the location information DB 4. Note that at a stage of this process 1, the terminal IP address is not yet acquired, and therefore “Null” is entered in the “terminal IP address” field in the corresponding record in the location information DB 4.

Process 2: DHCP IP Address Lease and Registration in SIP Server (SIP-REGISTER)

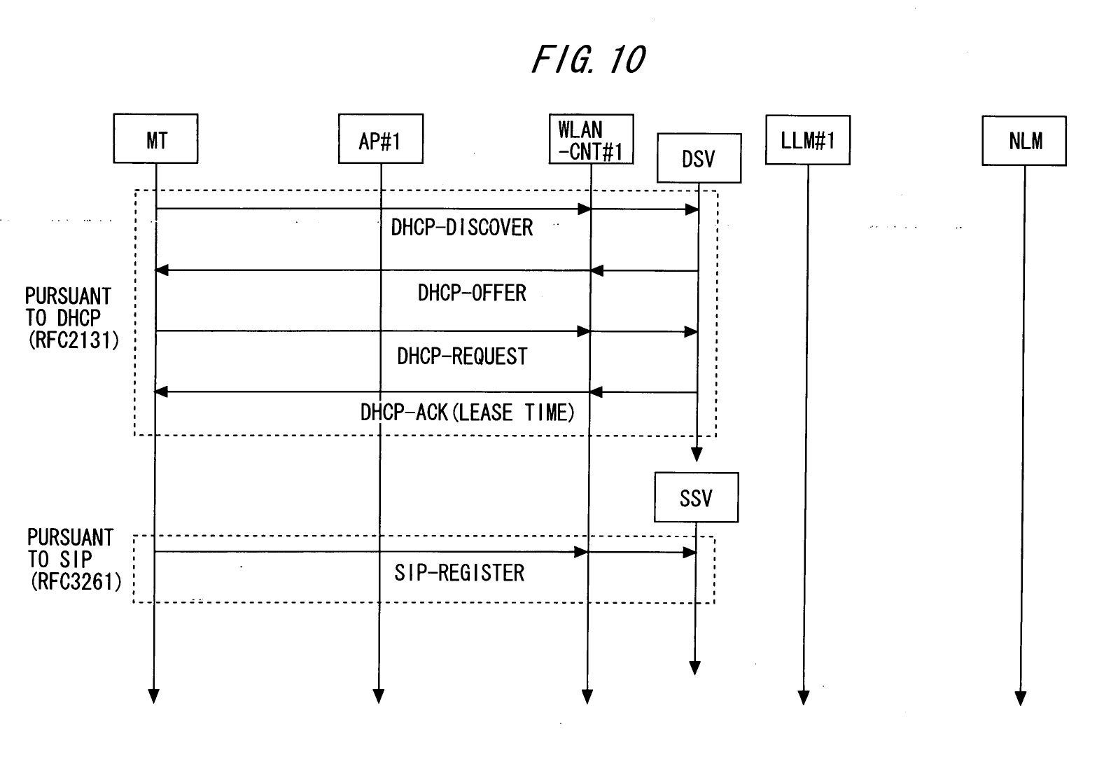

After the user authentication in the process 1, the terminal MT can access the communication network system SYS including the wireless LAN system WLAN. On this occasion, a process of leasing out (address lease) the IP address used for transmitting and receiving the data is executed. Moreover, for conducting IP telephony, when executing the registration (REGISTER) process in the SIP server SSV accommodated in the carrier area IP network R-IP-NW or the carrier relay IP network W-IP-NW from the terminal MT, a SIP message is captured (extracted), and then a SIP-URI is acquired (see FIG. 10 for more details).

(2-1) Acquisition of LLM Address of Location Information Transmitting Destination

The terminal MT, in the case of requesting the DHCP server DSV accommodated in the wired LAN to lease out the IP address, broadcasts a DHCP-Discover message. The wireless LAN controller WLAN-CNT (#1), after the WLAN processing unit 8 has received this DHCP-Discover message via the access point AP (#1), extracts the IP packet from the WLAN frame. The WLAN processing unit 8 transfers the extracted IP packet to the TCP/IP processing unit 2, and forwards the packet to the DHCP server DSV via the 10/100 Base-TX PHY/MAC 1. The remaining DHCP process, of which the details are shown in FIG. 10, is executed in the same procedures, and the wireless LAN controller WLAN-CNT receives a DHCP-ACK message from the DHCP server DSV, thereby leasing out the IP address to the terminal MT.

(2-2) Acquisition of SIP-URI

Further, the terminal MT, for conducting the IP telephony, makes the registration (of the location information) in the SIP server SSV. In the wireless LAN controller WLAN-CNT, the Operating System/TCP/IP processing unit 2 captures a SIP-REGISTER message sent toward the SIP server SSV from the terminal MT via the tunnel terminating unit 10 and captures the SIP-URI.

Process 3: Registration of Location Information

When the IP address is leased out to the terminal MT upon receiving the DHCP-ACK message in the process 2, in the wireless LAN controller WLAN-CNT, the WLAN processing unit 8 captures the MAC address of the terminal MT and the leased IP address thereof and transfers these addresses to the location information processing unit 3. The location information processing unit 3 searches through the location information DB 4 by use of the MAC address of the terminal MT as a search key, and writes (enters) the terminal IP address.

Process 4: Registration of Location Information of Terminal

The registration of the location information of the terminal MT in the wireless LAN controller WLAN-CNT is completed by the processes 1 through 3. Next, in the wireless LAN controller WLAN-CNT, the terminal location information is registered in the in-area location information management server LLM.

(4-1) Acquisition of LLM address of Transmitting Destination (Recipient) of Location Information

In the wireless LAN controller WLAN-CNT, a start of the process of the registration in the in-area location information management server LLM (LLM#1) is triggered by finishing the process 3. The location information processing unit 3 accesses the LM management DB 6 of the application/management unit 5 and thus acquires the IP address of the LLM defined as the location information registering destination.

(4-2) Selection and Transmission of Parameter of Location Information

The location information processing unit 3 transfers, among the items of terminal location information in the location information DB 4 shown in FIG. 5, the terminal MAC address, the terminal IP address, the user ID and the WLAN-CNT address (home location address) to the TCP/IP processing unit 2, and transmits these items of information to the in-area location information management server LLM as the registering destination via the 10/100 Base-TX PHY/MAC 1.

Process 5: Notification of Reception

The in-area location information management server LLM, after receiving the location information from the wireless LAN controller WLAN-CNT, notifies the wireless LAN controller WLAN-CNT that the location information has been properly received.

(5-1) Operation in LLM

The in-area location information management server LLM, after the 10/100 Base-TX PHY/MAC 1 has received the location information from the wireless LAN controller WLAN-CNT, transfers the location information to the Operating System/TCP/IP processing unit 22. The Operating System/TCP/IP processing unit 22 judges that this datagram (location information) is a location information related packet and then transfers this packet to the location information processing unit 23. The location information processing unit 23 sends a reply saying that the packet has been normally received to the wireless LAN controller WLAN-CNT. On this occasion, the location information processing unit 23 transfers a reception notification message to the TCP/IP processing unit 2 and sends this message to the wireless LAN controller WLAN-CNT via the 10/100 Base-TX PHY/MAC 21.

(5-2) Operation in WLAN-CNT

In the wireless LAN controller WLAN-CNT, the 10/100 Base-TX PHY/MAC 1, after receiving the reception notification message from the in-area location information management server LLM, transfers the message to the location information processing unit 3 via the Operating System/TCP/IP processing unit 2. The location information processing unit 3 recognizes that the in-area location information management server LLM has received the terminal location information in safety, and the location information registration process is thereby completed. If none of the notification is given from the in-area location information management server LLM, the message is retransmitted several times. If the reception notification does not come from the in-area location information management server LLM several times, it is regarded that an error occurs, and the application/management unit 5 is notified of an alarm.

Process 6: Registration of Location Information The in-area location information management server LLM, which has acquired the location information of the terminal MT in the process 5, registers this location information in the location information DB 25.

Process 7: Registration of Terminal Location Information

The registration of the location information of the terminal MT in the in-area location information management server LLM has been completed through the processes 4-6. The in-area location information management server LLM registers the terminal location information in the inter-wide-area location information management server NLM.

(7-1) Acquisition of NLM Address of Transmitting Destination (Recipient) of Location Information

In the in-area location information management server LLM, a start of the process of the registration in the inter-wide-area location information management server NLM is triggered by finishing the process 6. The location information processing unit 23 of the in-area location information management server LLM accesses the LM management DB 26 of the application/management unit 24, and thus acquires an IP address of the inter-wide-area location information management server NLM defined as the registering destination of the location information.

(7-2) Selection and Transmission of Parameter of Location Information

The location information processing unit 23 transfers, among items of terminal location information in the location information management table (location information DB) 25 shown in FIG. 6, the LLM address acquired from the LM management DB 26 together with the terminal MAC address and the user ID to the TCP/IP processing unit 22, and transmits these items of information to the inter-wide-area location information management server NLM defined as the registering destination via the 10/100 Base-TX PHY/MAC 21.

Process 8: Notification of Reception

The inter-wide-area location information management server NLM, after receiving the location information from the in-area location information management server LLM, notifies the in-area location information management server LLM that the location information has been properly received. On this occasion, the same operation as in the process 5 is executed.

Process 9: Registration of Location Information

The inter-wide-area location information management server NLM registers, in the location information DB 25, the location information of the terminal MT that has been acquired in the process 8.

### Operation B: Location Information Registration Procedure When Handover Occurs between APs

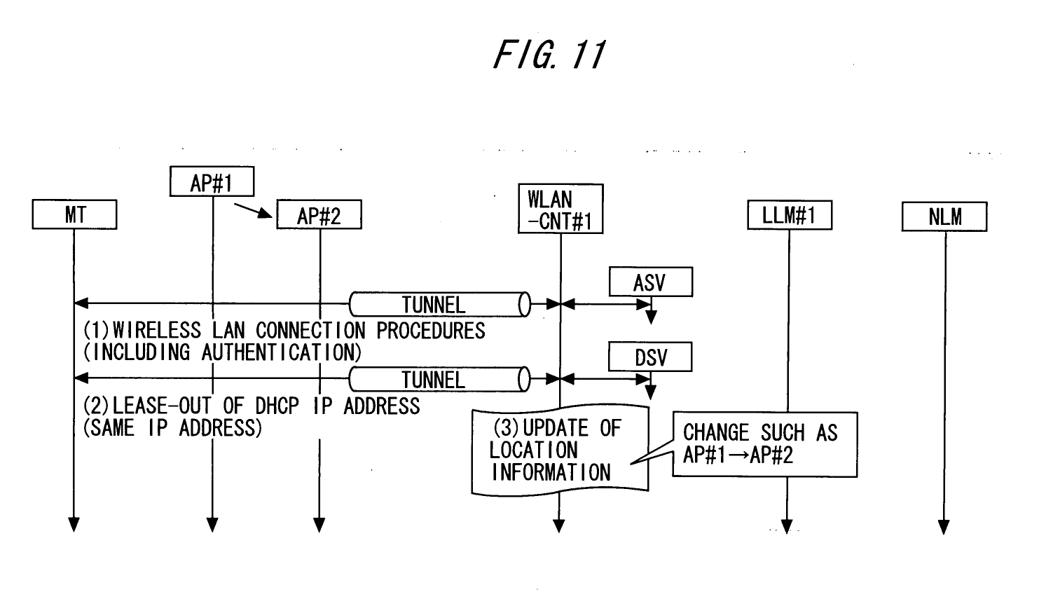

In the communication network system SYS in the first embodiment of The present invention, when the handover of the terminal MT occurs between the access points AP of the wireless LAN system WLAN, it is required that the connection is switched over to the access point AP of the visited location from the access point AP of the home location. Hereat, the DHCP server DSV leases out the same IP address to the terminal MT in order not to disconnect the mobile talk. Therefore, an updated item of location information in the wireless LAN controller WLAN-CNT (#1) is only the IP address of the access point AP (see FIG. 11).

Process 1: Wireless LAN connecting Procedure (Including User Authentication)

Referring to FIG. 11, when the handover of the terminal MT occurs between the access points AP (e.g., from AP#1 to AP#2) of the wireless LAN system WLAN, the terminal MT must connect to the access point AP (#2) according to the IEEE 802.11 procedures in order to communicate with the access point AP (#2) of the new visited location.

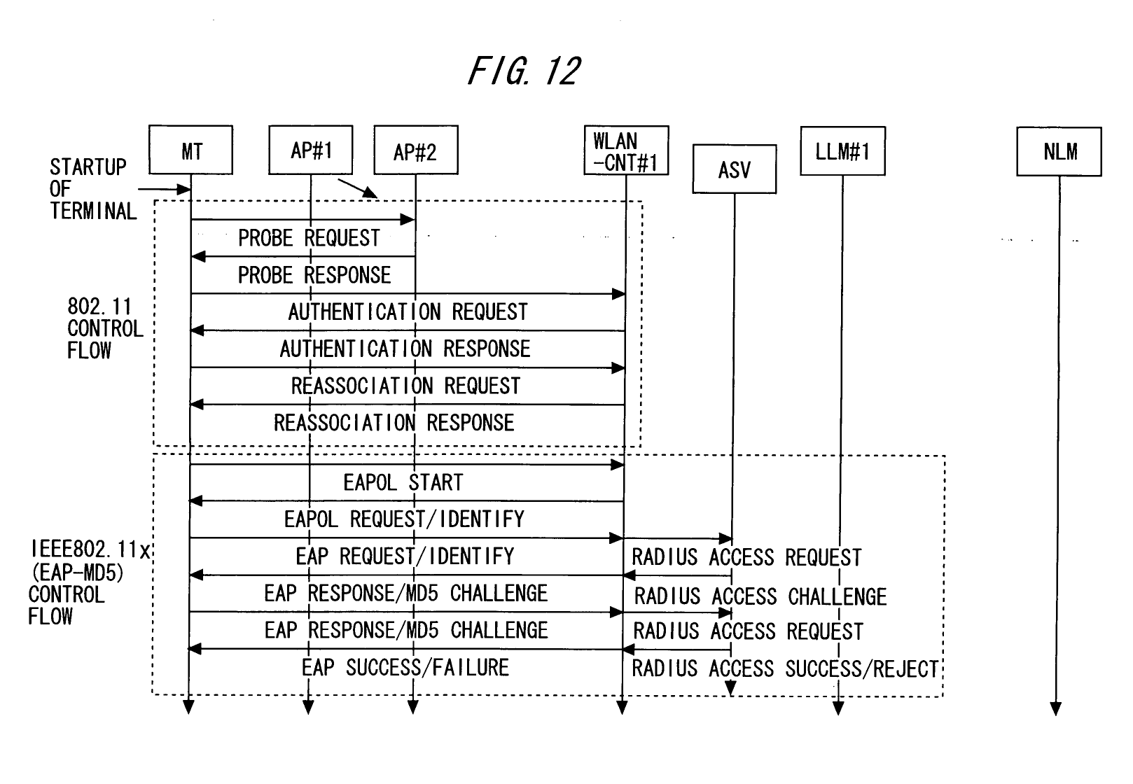

When the terminal MT utilized by the user accesses the wireless LAN system WLAN, the user is authenticated for checking whether or not the user is authorized for accessing (see FIG. 12 for more details) Therefore, the same process as the process 1 in the operation A is needed. On this occasion, in the wireless LAN controller WLAN-CNT (“1), the WLAN processing unit 8 transfers, to the location information processing unit 3, the IP address associated with the access point AP of the new visited location, and reregisters this IP address in the location information DB 4.

Process 2: Lease-out of DHCP IP Address

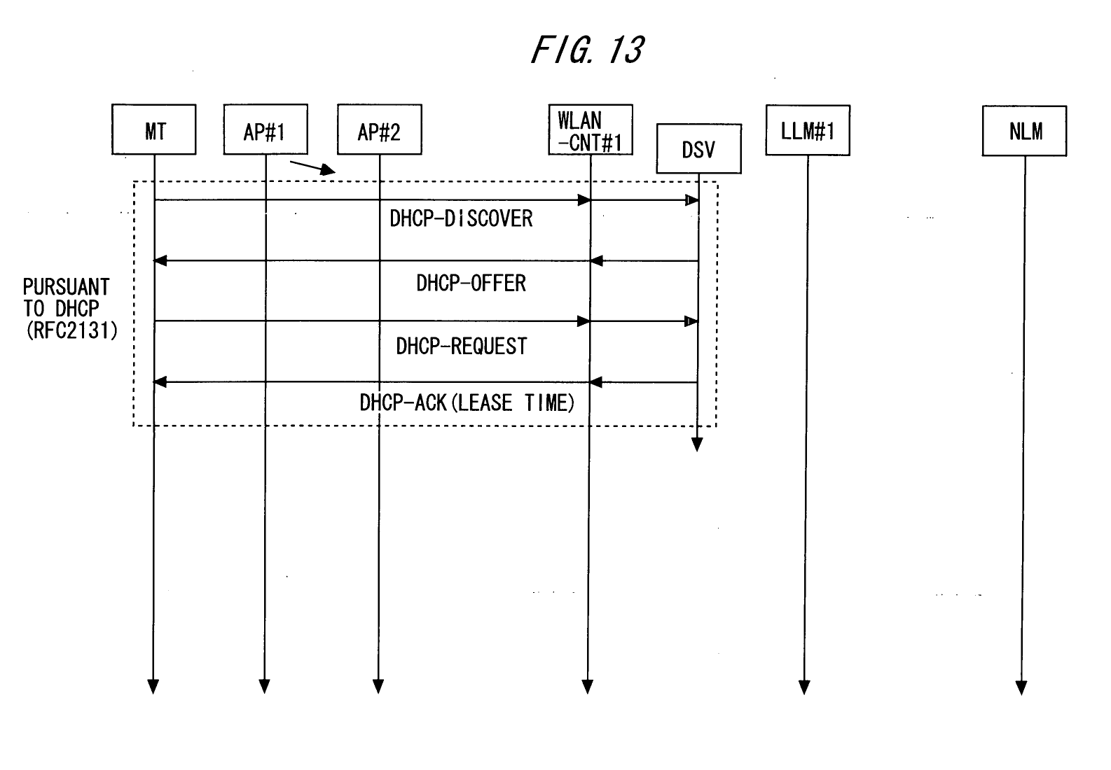

After the user authentication in the process 1, the terminal MT can access the communication network system SYS including the wireless LAN system WLAN. On this occasion, the process of leasing out (address lease) the same IP address used for transmitting and receiving the data is executed (see FIG. 13 for more details). The specific processing procedures are the same as those in the process 2 in the operation A.

Process 3: Update of Location Information

When the same IP address is leased out again to the terminal MT upon receiving the DHCP-ACK message in the process 2, in the wireless LAN controller WLAN-CNT, the WLAN processing unit 8 captures the MAC address of the terminal MT and the leased IP address thereof, and transfers these addresses to the location information processing unit 3. The location information processing unit 3 searches through the location information DB 4 by use of the MAC address of the terminal MT as a search key, and updates the terminal IP address.

### Operation C: Location Information Registration Procedure When Handover Occurs between WLAN and CNT

In the communication network system SYS in the first embodiment of The present invention, when the handover of the terminal MT occurs between the wireless LAN controllers WLAN-CNT, it is necessary to switch over the connection from the access point AP of the home location to the access point AP of the visited location. At this time, the requirement is that a tunnel connection to the wireless LAN controller WLAN-CNT of the home location be established in order not to disconnect the mobile talk, the same IP address be acquired from the DHCP server DSV, and the packet be forwarded.

For attaining this scheme, the wireless LAN controller WLAN-CNT (#2) of the visited location is, at first, registered with an address of the WALN-CNT of the visited location and an AP (access point) address that are associated with the MAC address of the terminal MT. Thereafter, the wireless LAN controller WLAN-CNT (#2) of the visited location queries the in-area location information management server LLM (#1) about the home location WLAN-CNT address via the carrier area IP network R-IP-NW (#1).

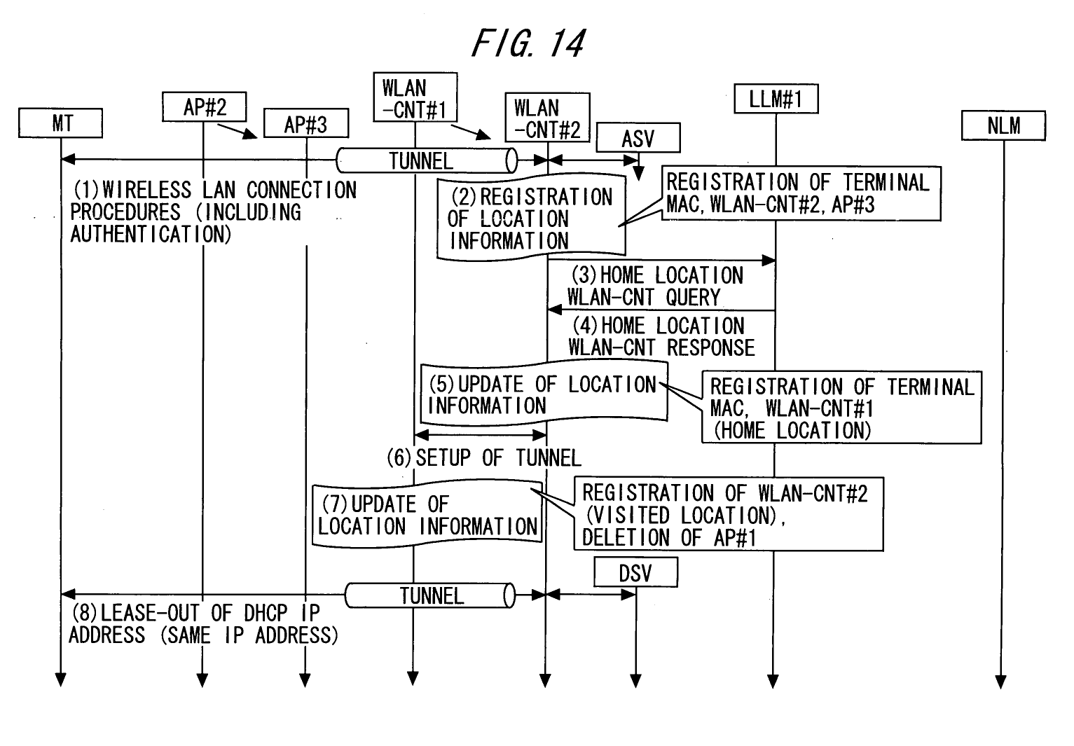

Established based on a result of this query is the tunnel of the communication line to the wireless LAN controller WLAN-CNT (#1) of the home location from the wireless LAN controller WLAN-CNT (#2) of the visited location. On this occasion, in the wireless LAN controller WLAN-CNT (#1) of the home location and in the wireless LAN controller WLAN-CNT (#2) of the visited location, the location information processing units 3 register the WLAN-CNT addresses in the location information databases DB 4 each other (see FIG. 14).

Process 1: Wireless LAN Connecting Procedure (Including User Authentication)

In the same way as in the process 1 of the operation B, when the handover of the terminal MT utilized by the user takes place, the terminal MT must connect to the access point AP (#3) of the wireless. LAN controller WLAN-CNT according to the IEEE802.11 procedures in order to communicate with the access point AP (#3) of the new visited location. When accessing the wireless LAN system WLAN, the user is authenticated for checking whether or not the user is authorized for accessing. The specific processing procedures are the same as those in the processes 1 (1-1) and 1 (1-2) of the operation A.

Process 2: Registration of Location Information

When in the user authentication process of the process 1, the user authentication information such as the terminal MAC address and the user ID is acquired, and the location information DB 4 is registered with the user authentication information together with the IP address associated with the access point AP of the visited location. The specific procedures are the same as those in the process 1 (1-3) of the operation A.

Process 3: Home Location WLAN-CNT Query

When the handover of the terminal MT occurs between the wireless LAN controllers WLAN-CNT, to begin with, for establishing the tunnel connection between the wireless LAN controller WLAN-CNT (#1) of the home location and the wireless LAN controller WLAN-CNT (“2) of the visited location, the address of the wireless LAN controller WLAN-CNT of the home location must be acquired. For this acquisition, the in-area location information management server LLM (#1) is queried about an address of the home location WLAN-CNT by use of the MAC address of the terminal MT as a search key.

(3-1) Acquisition of Address of Location Information Queried Server LLM

The specific processing procedures are the same as those in the process 4 of the operation A.

(3-2) Selection and Transmission of Location Information Query Parameter

The location information processing unit 3 transfers, among the items of terminal location information in the location information DB 4 shown in FIG. 5, only the terminal MAC address to the TCP/IP processing unit 2 and transmits this address to the registering destination server LLM via the 10/100 Base-TX PHY/MAC 1.

Process 4: Response to Home Location WLAN-CNT

The in-area location information management server LLM (#1), after receiving a location information query message sent from the wireless LAN controller WLAN-CNT (#2), retrieves the location information from the location information DB 25 by using the terminal MAC address as a search key, and sends a response to the wireless LAN controller WLAN-CNT.

(4-1) Operation In LLM

The in-area location information management server LLM, after the 10/100 Base-TX PHY/MAC 21 have received the location information query message sent from the wireless LAN controller WLAN-CNT, transfers the message to the Operating System/TCP/IP processing unit 22. The Operating System/TCP/IP processing unit 22 judges that this message is a location information related packet, and transfers this message (packet) to the location information processing unit 23. The location information processing unit 23 judges that this message is the location information query, and searches the location information DB 25 for the address of the home location WLAN-CNT by employing the terminal MAC address as a search key. The location information processing unit 23 sends a result of this search back to the wireless LAN controller WLAN-CNT. On this occasion, the searched address is transferred to the TCP/IP processing unit 22 and transmitted to the wireless LAN controller WLAN-CNT (#2) via the 10/100 Base-TX PHY/MAC 21.

(4-2) Operation in WLAN-CNT

The wireless LAN controller WLAN-CNT, after the 10/100 Base-TX PHY/MAC 1 has received a WLAN-CNT response packet from the in-area location information management server LLM, transfers this response packet to the location information processing unit 3 via the Operating System/TCP/IP processing unit 2.

Process 5: Update of Location Information

The wireless LAN controller WLAN-CNT (#2) of the visited location, after receiving the address of the home location WLAN-CNT, updates the location information DB 4. The location information processing unit 3, in the case of receiving the home location WLAN-CNT address, searches through the location information DB 4 by use of the terminal MAC address as a search key.

Then, the location information processing unit 3 executes the following process with respect to the searched WLAN-CNT address and the received WLAN-CNT address. Namely, the already-registered WLAN-CNT address (home location address) is copied (mapped) to the WLAN-CNT address (visited location address). Further, the received WLAN-CNT address is copied (mapped) to the WLAN-CNT address (home location address).

Process 6: Setup of Tunnel

The transmission and the reception of the user packet via the wireless LAN controllers WLAN-CNT (#1, #2) of the home location and the visited location, involve establishing the tunnel connection of the communication line from the wireless LAN controller WLAN-CNT (#2) of the visited location to the wireless LAN controller WLAN-CNT (#1) of the home location. For this tunneling, the location information processing unit 3 sends a tunnel connection processing request to the tunnel terminating unit 10 via the WLAN processing unit 8. As for the tunnel connection processing procedures, though different depending on a tunnel connection method (tunneling algorithm), basically a control message is transmitted and received between the tunnel terminating units 10 of the wireless LAN controllers WLAN-CNT, thus establishing the tunnel connection.

Process 7: Update of Location Information

When establishing the tunnel connection, the wireless LAN controller WLAN-CNT (#1) of the home location updates the location information. In the wireless LAN controller WLAN-CNT of the home location, the location information processing unit 3, when receiving the address of the home location WLAN-CNT, searches through the location information DB 4 by using the terminal MAC address as a search key.

The location information processing unit 3 executes the following process with respect to the searched WLAN-CNT address and the received WLAN-CNT address. Namely, the already-registered WLAN-CNT address (home location address) remains unchanged. The received WLAN-CNT address is copied (mapped) to the WLAN-CNT address (visited location address). Further, the AP address is deleted.

Process 8: Lease-out of DHCP IP Address

In the wireless LAN controller WLAN-CNT (#2) of the visited location, it is required that the DHCP message be transmitted and received via the tunnel to the wireless LAN controller WLAN-CNT (#1) of the home location, the same IP address be acquired from the DHCP server DSV, and the packet be forwarded. If the wireless LAN controller WLAN-CNT of the visited location transmits the DHCP packet of the terminal MT directly to the DHCP server DSV, an IP address for a different subnet is leased out with the result that the communications can not continue, and hence it is necessary to transfer the DHCP packet to the DHCP server DSV from the wireless LAN controller WLAN-CNT of the home location via the tunnel.

Therefore, the TCP/IP processing unit 2 transfers the DHCP packet received from the terminal MT to the wireless LAN controller WLAN-CNT of the home location from the wireless LAN controller WLAN-CNT of the visited location by employing the tunnel terminating unit 10, and transmits the packet to the DHCP server DSV.

### Operation D: Location Information Registration Procedures When Handover Occurs Between Servers LLM

In the communication network system SYS in the first embodiment of The present invention, basically, the location information is registered and updated by using the same procedures as those of the operation C, however, in the handover with respect to the wireless LAN controller WLAN-CNT (#3) in relation to one other in-area location information management server LLM (#2), the in-area location information management server LLM (#2) does not know the address of the home location WLAN-CNT and therefore queries the inter-wide-area location information management server NLM defined as a higher-order LM server.

The inter-wide-area location information management server NLM stores (retains) the home location LLM address as the present location information of the terminal MT, and it is therefore possible to query the in-area location information management server LLM of the home location in response to a query sent from the in-area location information management server LLM of the visited location, whereby a response of the home location WLAN-CNT address can be given. Through these procedures, it is feasible to set up the tunnel of the communication line to the wireless LAN controller WLAN-CNT of the home location from the wireless LAN controller WLAN-CNT of the visited location.

Furthermore, when the terminal MT performs roaming (moving in a terminal standby status), the DHCP server DSV of the visited location assigns a new IP address to the terminal MT, and hence the procedures are basically the same as the procedures at the terminal startup time. The location information is not, however, required to be updated in the inter-wide-area location information management server NLM that does not manage the IP address of the terminal MT.

Process 1: Wireless LAN Connection Procedure (Including User Authentication)

The specific processing content and procedures are the same as those in the processes 1 (1-1) and 1 (1-2) of the operation A.

Process 2: Registration of Location Information

The specific processing content and procedures are the same as those in the process 1 (1-3) of the operation A.

Process 3: Home Location WLAN-CNT Query

When the handover of the terminal MT occurs between the wireless LAN controllers WLAN-CNT (#2, #3) subordinate to the different in-area location information management servers LLM (#1, #2), at first, for establishing the tunnel connection between the wireless LAN controllers WLAN-CNT of the home location and of the visited location, the address of the home location WLAN-CNT must be acquired. For this address acquisition, the wireless LAN controller WLAN-CNT (#3) of the visited location queries the in-area location information management server LLM accommodated in the carrier area IP network R-IP-NW (#2) about the address of the home location WLAN-CNT. The specific processing content and procedures are the same as those in the process 3 of the operation C.

Process 4: Home Location LLM Query

When the handover of the terminal MT occurs between the wireless LAN controllers WLAN-CNT (#2, #3) subordinate to the different in-area location information management servers LLM (#1, #2), this communication network system SYS does not take a method of making a response to a WLAN-CNT address query to the high-order in-area location information management server LLM.

Therefore, the in-area location information management server LLM (#2) of the visited location queries the higher-order inter-wide-area location information management server NLM accommodated in the carrier relay IP network W-IP-NW.

Namely, in the in-area location information management server LLM (#2) of the visited location, the location information processing unit 23 requests the application/management unit 24 to search the LM management DB 26 for an NLM address. The location information processing unit 23 queries the inter-wide-area location information management server NLM associated with the address obtained as a result of the search about an associated LLM address by transmitting the terminal MAC address.

Process 5: Home Location LLM Response

As a result of the process 4, in the inter-wide-area location information management server NLM, the location information processing unit 23 receives the home location LLM query given from the in-area location information management server LLM of the visited location. The location information processing unit 23 searches the location information DB 25 for the registered LLM address by using the terminal MAC address as a search key.

(5-1) Operation in NLM

In the inter-wide-area location information management server NLM, after the 10/100 Base-TX PHY/MAC 21 has received the location information query message from the in-area location information management server LLM (#2), the message is transferred to the Operating System/TCP/IP processing unit 22. The Operating System/TCP/IP processing unit 22 judges that this message is a location information related packet and transfers this packet to the location information processing unit 23.

The location information processing unit 23 judges that this message (packet) is a query about the location information, and searches the location information DB 25 for the LLM address of the in-area location information management server LLM of the home location by employing the terminal MAC address as a search key. The location information processing unit 23 sends a result of this search back to the wireless LAN controller WLAN-CNT. On this occasion, the location information processing unit 23 transfers the search result (address) to the TCP/IP processing unit 22 and transmits this address to the wireless LAN controller WLAN-CNT via the 10/100 Base-TX PHY/MAC 21.

(5-2) Operation in LLM

In the in-area location information management server LLM (#2), after the 10/100 Base-TX PHY/MAC 21 has received a home location LLM response packet from the inter-wide-area location information management server NLM, this LLM response packet is transferred to the location information processing unit 23 via the Operating System/TCP/IP processing unit 22.

Process 6: Home Location WLAN-CNT Query

The in-area location information management server LLM (#2) of the visited location queries the in-area location information management server LLM (#1) about the home location WLAN-CNT address. In the in-area location information management server LLM of the visited location, the location information processing unit 23 transmits the terminal MAC address to the in-area location information management server LLM associated with the received home location LLM address, and queries about the associated home location WLAN-CNT address.

Process 7: Home Location WLAN-CNT Response

In the in-area location information management server LLM (#1) of the home location, the location information processing unit 23 receives the query from the in-area location information management server LLM (#2) of the visited location. The location information processing unit 23 searches the location information DB 25 for the registered WLAN-CNT address by using the terminal MAC address as a search key.

(7-1) Operation in Home Location LLM

In the in-area location information management server LLM (#1) of the home location, the 10/100 Base-TX PHY/MAC 21, after receiving the location information query message from the in-area location information management server LLM (#2) of the visited location, transfers this message to the Operating System/TCP/IP processing unit 22. The Operating System/TCP/IP processing unit 22 judges that this message is a location information related packet and transfers this packet to the location information 1 processing unit 23.

The location information processing unit 23 judges that the packet is a query about the location information, and searches the location information DB 25 for the home location WLAN-CNT address by employing the terminal MAC address as a search key. The location information processing unit 23 sends a result of this search back to the in-area location information management server LLM (#2). On this occasion, the location information processing unit 23 transfers the search result (WLAN-CNT address) to the TCP/IP processing unit 22 and transmits this search result to the in-area location information management server LLM (#2) via the 10/100 Base-TX PHY/MAC 21.

(7-2) Operation in Visited Location LLM

In the in-area location information management server LLM (#2) of the visited location, the 10/100 Base-TX PHY/MAC 21, after receiving a WLAN-CNT response packet from the in-area location information management server LLM (#1) of the home location, transfers this response packet to the location information processing unit 23 via the Operating System/TCP/IP processing unit 22.

Process 8; Home Location WLAN-CNT Response

The in-area location information management server LLM (#2), after receiving a location information query message from the in-area location information management server LLM (#1) of the home location, sends the home location WLAN-CNT address back to the wireless LAN controller WLAN-CNT (#3) of the visited location. The specific processing content and procedures are the same as those in the process 4 of the operation C.

Process 9: Update of Location Information

The specific processing content and procedures are the same as those in the process 5 of the operation C.

Process 10: Setup of Tunnel

The specific processing content and procedures are the same as those in the process 6 of the operation C.

Process 11: Update of Location Information The specific processing content and procedures are the same as those in the process 7 of the operation C.

Process 12: Lease-Out of DHCP IP Address

The specific processing content and procedures are the same as those in the process 8 of the operation C.

### Effect of First Embodiment

When starting up the mobile terminal MT, when the handover to one other wireless zone occurs or when roaming, the wireless LAN controller WLAN-CNT, the in-area location information management server LLM and the inter-wide-area location information management server NLM can efficiently manage (register and update) the location information of the mobile terminal MT.

Further, when the mobile terminal MT moves across the wireless zone within the area, it may be sufficient to update only the location information managed by the in-area location information management server LLM, while there is no necessity of updating the location information managed by the inter-wide-area location information management server NLM, and it is possible to prevent (an increase in) the load upon the inter-wide-area location information management server NLM.

In the present situation, in the large-scale network, if the items of location information are managed by one single server, there is the necessity of transmitting and receiving the mobile information (location information) to and from the same server each time a tremendous number of mobile terminals move, and hence this is not realistic and is hard to actualize. It is therefore possible to support the large-scale network by efficiently managing the location information in a way that hierarchizes the location information.

The IP cell phone networks ranging from the small scale up to the large scale, which utilize the wireless LAN systems, can be configured by utilizing the location information management function described above and further taking a combination with the SIP call control protocol.

### Second Embodiment

### Example of Architecture of Communication Network System

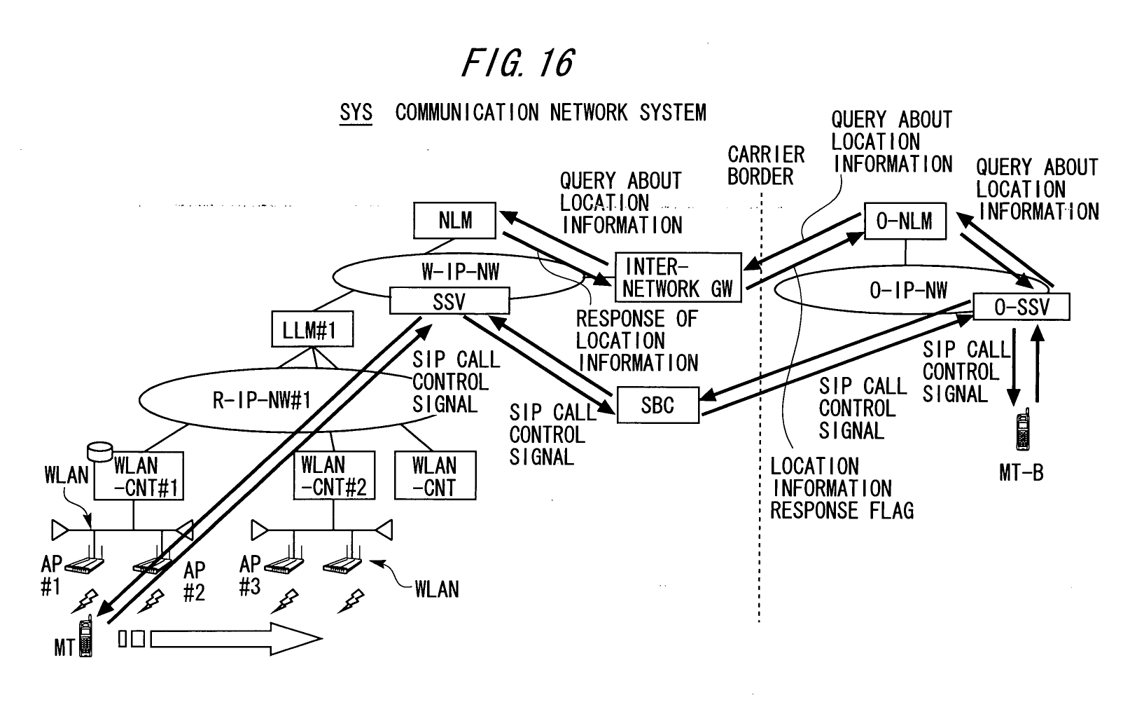

Next, an architecture of the communication network system in a second embodiment of the present invention will be explained. Referring to FIG. 16, this communication network system SYS, as in the case of the communication network system SYS in the first embodiment, configures a large-scale wide area network system having the location information management function for the mobile terminal MT such as the IP cell phone terminal and the PDA that utilize the wireless LAN system WLAN.

In each wireless LAN system WLAN, a plurality of access points (which are, strictly, communication control devices configuring the access points) AP is theoretically cascade-connected to a wired network configured by a wired LAN.

A wireless zone (wireless LAN zone or a service area) subordinate to each access point AP uses different wireless channels (wireless lines). Accordingly, each access point AP and each mobile terminal MT operate (communicate) by wireless frequency signals assigned to the access point AP and the terminal, respectively.

Each wireless LAN system WLAN includes a wireless LAN controller WLAN-CNT and a DHCP server DSV (of which an illustration is omitted) each connected to the wired LAN. Only the single DHCP server DSV can be also provided for the plurality of wireless LAN systems WLAN.

The wireless LAN controller WLAN-CNT of each wireless LAN system WLAN is connected to carrier area IP networks R-IP-NW (#1, #2) that cover the areas and are administered by the same carrier (the common carrier or simply the carrier). Herein, only the carrier area IP network R-IP-NW (#1) is illustrated as a representative network, however, in the same way as in the communication network system SYS in the first embodiment shown in FIG. 2, the respective carrier area IP networks R-IP-NW exist in geographically (locally) different areas such as the Kanto region or the Kansai region or the largest administrative units of Japanese local government. The carrier area IP network R-IP-NW has the in-area location information management server LLM (#1).

The carrier area IP network R-IP-NW (#1) and the in-area location information management server LLM (#1) are connected to the carrier relay IP network (wide area IP network) W-IP-NW. The carrier relay IP network W-IP-NW has the inter-wide-area location information management server NLM.

In the communication network system SYS in the second embodiment, in the same way as in the communication network system SYS in the first embodiment, the location information management servers are hierarchized within the area and between the wide areas, and are disposed as the in-area location information management servers LLM and the inter-wide-area location information management servers NLM. Then, these control devices (controllers) including the wireless LAN controllers WLAN-CNT share functions as follows. To be specific, each wireless LAN controller WLAN-CNT manages home location information and visited location information of the mobile terminal MT. Each of the in-area location information management servers LLM manages detailed location information of the mobile terminal MT. Further, the inter-wide-area location information management server NLM has a feature of managing rough location information of the mobile terminal MT.

Configurations of the wireless LAN controller WLAN-CNT, the in-area location information management server LLM and the inter-wide-area location information management server NLM, which serve to manage the location information of the mobile terminal MT, are as illustrated in FIGS. 3 and 4.

Further, structures of the location information management tables 4, 25 in the wireless LAN controller WLAN-CNT, the in-area location information management server LLM and the inter-wide-area location information management server NLM, are as shown in FIGS. 5, 6 and 7.

The communication network system SYS in the second embodiment has a further feature that follows. In this communication network system SYS, an assumption is to link up on an application basis with other carrier networks O-IP-NW, wherein an item of existing-in-zone information is replied as the location information of the mobile terminal MT in response to a query about the location information from the other carrier network O-IP-NW. In response to the location information query from the inter-wide-area location information management server NLM (O-NLM) in the other carrier network O-IP-NW, a query is given to the inter-wide-area location information management server NLM attached to the self-carrier via the inter-network gateway GW. The inter-network gateway GW temporarily terminates the response from the self-carrier NLM, and a response is given to the other carrier network O-IP-NW in a way that sets a flag about only whether or not the user accesses under the control of the self-carrier network S-IP-NW (the carrier area IP network R-IP-NW and the carrier relay IP network W-IP-NW).

Moreover, a SIP server SSV operating based on a call control protocol SIP in the IP telephony is combined with the inter-wide-area location information management server NLM, and a SIP-based INVITE message may also be redirected to an IP phone interconnecting device SBC (Session Border Controller). This scheme enables the interconnection between other carriers for the IP telephony.

There might be a case in which the SIP server is not registered with a communication partner terminal's SIP-URI and can not acquire the IP address of the SIP server to which the IP address of the communication partner terminal or the SIP-based INVITE message is transferred. Especially if an IP phone user might hereafter become capable of roaming between the carriers, there arises a case of being unable to specify, from the SIP-URI of the communication partner terminal, which carrier network the terminal gets roaming in, however, the communication network system SYS in the second embodiment can handle this problem.

### Operational Example of Communication Network System

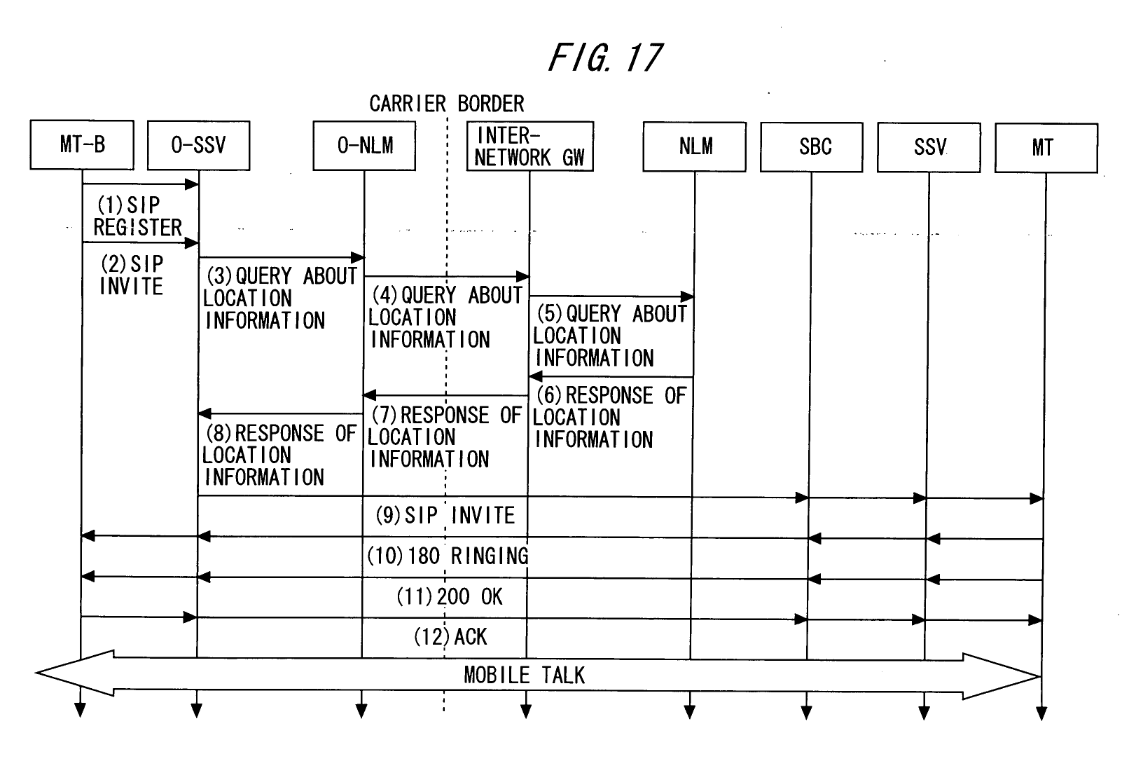

Next, an operational example of the communication network system SYS in the second embodiment of The present invention shown in FIG. 16, will be explained with reference to relational diagrams (FIG. 17 etc). Note that circled numerals represent procedure numbers of the processes throughout the drawings for illustrating the operational example.

Process 1: Registration in SIP Server (SIP REGISTER)

Referring to FIGS. 16 and 17, after the user making a subscription to the other carrier network O-IP-NW administered by one other carrier has started up (power-on) a mobile terminal MT-B such as an IP cell phone terminal, a SIP REGISTER message serving as a SIP cal control signal is sent to the other SIP server O-SSV accommodated in the other carrier network O-IP-NW, and the user is thus entered as an active user.

Process 2: SIP INVITE

When the subscriber user of the other carrier network O-IP-NW telephones the mobile terminal MT utilized by the subscriber user of the self-carrier network S-IP-NW, in this communication network system SYS, the SIP INVITE message serving as the SIP call control signal is transferred via the SIP server O-SSV in order to establish a call session.

Process 3: Query about Location Information

If the other carrier SIP server O-SSV is not registered with the communication partner terminal's SIP-URI and is unable to acquire the IP address of the SIP server SSV (SBC) to which the IP address of the communication partner terminal or the SIP INVITE message is transferred, to begin with, a query is given to an inter-wide-area location information management server O-NLM accommodated in the other carrier network O-IP-NW. On this occasion, this scheme does not need any special protocol and can be supported by an existing DNS (Domain Name System) protocol etc.

Process 4: Query about Location Information

The inter-wide-area location information management server O-NLM queries all of inter-network gateways GW (one type of LLM) of the carriers each making a roaming contract about the location information in a way that uses the SIP-URI of the terminal MT-B as a search key.

In the inter-wide-area location information management server O-NLM, the location information processing unit 23 receives the query from the SIP server O-SSV via the 10/100 Base-TX PHY/MAC 21 and via the Operating System/TCP/IP processing unit 22. The location information processing unit 23, however, since the target location information does not exist in the network (the other carrier network O-IP-NW) attached to the self-carrier, queries the network (the self-carrier network S-IP-NW) attached to the other carrier.

At this time, the location information processing unit 23, without changing contents of the received message, searches through the LM management DB 26 and further transfers the query message to all the registered inter-network gateways GW (having the roaming contract) via the Operating System/TCP/IP processing unit 22 and via the 10/100 Base-TX PHY/MAC 21.

Process 5; Query about Location Information

The inter-network gateway GW queries the inter-wide-area location information management server NLM in the self-carrier network S-IP-NW by employing the SIP-URI of the terminal MT as key information. In the inter-network gateway GW, though an illustration of the detailed configuration is omitted, the location information processing unit receives the query from the inter-wide-area location information management server O-NLM of the other carrier via the 10/100 Base-TX PHY/MAC and the Operating System/TCP/IP processing unit that have the same components as those of the in-area location information management server LLM.

The inter-network gateway GW queries the inter-wide-area location information management server NLM within the self-carrier network S-IP-NW about the location information of the terminal MT, therefore searches through, without changing the contents of the received message, the LM management DB and further transfers the query message to the inter-wide-area location information management servers NLM registered in this LM management DB via the Operating System/TCP/IP processing unit and the 10/100 Base-TX PHY/MAC.

Process 6: Location Information Response

The inter-wide-area location information management server NLM within the self-carrier network S-IP-NW queries about the location information by employing the SIP-URI of the terminal MT as a search key, and sends a search result as a response to the inter-network gateway GW.

Namely, the inter-wide-area location information management server NLM, after the 10/100 Base-TX PHY/MAC 21 has received the location information query message from the inter-network gateway GW, transfers this message to the Operating System/TCP/IP processing unit 22. The Operating System/TCP/IP processing unit 22 judges that this message is a location information related packet and transfers this packet to the location information processing unit 23. The location information processing unit 23 judges this packet to be the query about the location information, and searches the location information DB 25 for the LLM address by employing the SIP-URI as a search key. If the terminal MT does not exist in the zone of the self-carrier network S-IP-NW, the location information processing unit 23 responds that the LLM addresses are all “0”.

Process 7: Location Information Response

The inter-network gateway GW, based on the location information of the terminal MT that is given from the inter-wide-area location information management server NLM, sets a location information response flag if the terminal MT exists in the zone but does not set the flag whereas if not existing in the zone, and gives a response to the inter-wide-area location information management server O-NLM of the other carrier. In the inter-network gateway GW, the location information processing unit receives the response from the inter-wide-area location information management server NLM of the self carrier via the 10/100 Base-TX PHY/MAC and the Operating System/TCP/IP processing unit.

The location information processing unit judges, based on the LLM address, whether the terminal MT is in an existing-in-zone status or a non-existing-in-zone status in the following way, thus setting or resetting the location information response flag. When the terminal MT exists in the zone and when the LLM address is a value other than “0”, the location information response flag is set. Further, when the terminal MT does not exist in the zone and when the LLM address is “0”, the location information response flag is reset.

The inter-network gateway GW sends the contents as a location information response message back to the inter-wide-area location information management server O-NLM of the other carrier. Hereat, the inter-network gateway GW gives the response to the inter-wide-area location information management server O-NLM of the other carrier making the query about the location information via the Operating System/TCP/IP processing unit and the 10/100 Base-TX PHY/MAC.

Process 8; Location Information Response

The inter-wide-area location information management server O-NLM of the other carrier sends back, based on the terminal existing-in-zone information given from the inter-network gateway GW, the information (IP address) of the connecting destination SBC as a response.

In the other carrier NLM, the location information processing unit 23 receives the terminal existing-in-zone information from the inter-network gateway GW via the 10/100 Base-TX PHY/MAC 21 and the Operating System/TCP/IP processing unit 22.

The location information processing unit 23 judges as follows based on the existing-in-zone information representing the existing-in-zone status or the non-existing-in-zone status of the terminal MT, and sends back the information of the connecting destination SBC as a response. Namely, when the terminal MT exists in the zone, the location information processing unit 23 sends back the SBC address of the connecting destination (to which the SIP message is transferred) as a response to the inter-network gateway GW of the existing-in-zone carrier. Further, when the terminal MT is in the non-existing-in-zone status, the location information processing unit 23 responds that the SBC addresses are all “0” (no connecting destination).

The inter-wide-area location information management server O-NLM of the other carrier sends the contents as the location information response message back to the SIP server O-SSV of the other carrier. At this time, the location information processing unit 23 of the inter-wide-area location information management server O-NLM of the other carrier gives the response to the SIP server O-SSV of the other carrier making the query about the location information via the Operating System/TCP/IP processing unit 22 and the 10/100 Base-TX PHY/MAC 21.

Process 9: SIP INVITE

The SIP server O-SSV of the other carrier can specify, according to the procedures up to the process 8 described above, the carrier network in which the terminal MT with whom the terminal MT-B communicates (talks) exists, and transfers the SIP INVITE message as the SIP call control signal to the existing-in-zone carrier SBC.

Processes 10, 11, 12: 180 Ringing, 200 OK, ACK

In this communication network system SYS, in processes 10 through 12, the call session is established based on the normal SIP call processing procedures.

In the series of processes 1 through 12, even when the user utilizing the mobile terminal MT such as the IP cell phone terminal gets roaming to the other carrier network, the location information can be acquired, and the call connection can be established.

### Effect of Second Embodiment

In the communication network system SYS in the second embodiment, the IP cell phone network can be interconnected with the IP cell phone networks of not only the self-carrier but also the other carrier.

Further, the security can be strengthened by concealing the detailed location information of the mobile terminal MT with respect to the query about the location information of the mobile terminal MT from the other carrier network O-IP-NW and by responding with only a flag bit representing the existing-in-zone status under the control of the self-carrier network S-IP-NW.

### Third Embodiment

### Example of Architecture of Communication Network System

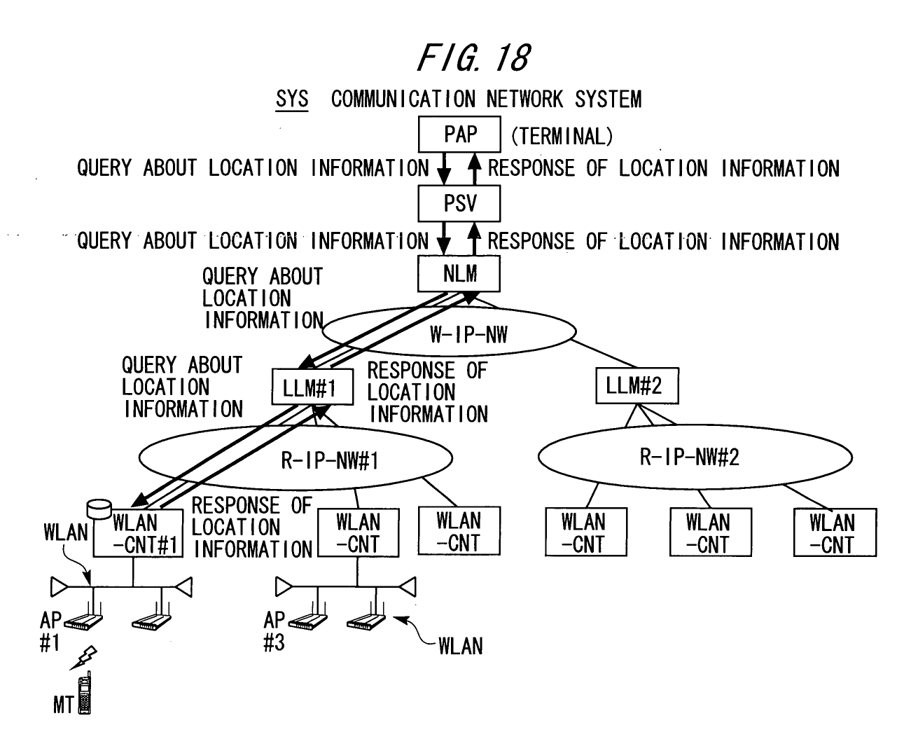

Next, an architecture of the communication network system in a third embodiment of the present invention will be explained. Referring to FIG. 18, this communication network system SYS, as in the case of the communication network system SYS in the first embodiment, configures a large-scale wide area network system having the location information management function for the mobile terminal MT such as the IP cell phone terminal and the PDA that utilize the wireless LAN system WLAN.

In each wireless LAN system WLAN, a plurality of access points (which are, strictly, communication control devices configuring the access points) AP is theoretically cascade-connected to a wired network configured by a wired LAN.

A wireless zone (wireless LAN zone or a service area) subordinate to each access point AP uses different wireless channels (wireless lines). Accordingly, each access point AP and each mobile terminal MT operate (communicate) by wireless frequency signals assigned to the access point AP and the terminal, respectively.

Each wireless LAN system WLAN includes a wireless LAN controller WLAN-CNT and a DHCP server DSV (of which an illustration is omitted) each connected to the wired LAN. Only the single DHCP server DSV can be also provided for the plurality of wireless LAN systems WLAN.

The wireless LAN controller WLAN-CNT of each wireless LAN system WLAN is connected to carrier area IP networks R-IP-NW that cover the areas and are administered by the same carrier (the common carrier or simply the carrier) Herein, the two carrier area R-IP networks IP-NW (#1, #2) exist in geographically (locally) different areas such as the Kanto region or the Kansai region or the largest administrative units of Japanese local government. Each carrier area IP network R-IP-NW has the in-area location information management servers LLM (#1, #2).

The two carrier area IP networks R-IP-NW and the two in-area location information management servers LLM are connected to the carrier relay IP network (wide area IP network) W-IP-NW. The carrier relay IP network IP network W-IP-NW has the inter-wide-area location information management server NLM.

In the communication network system SYS in the third embodiment, in the same way as in the communication network system SYS in the first embodiment, the location information management servers are hierarchized within the area and between the wide areas, and are disposed as the in-area location information management servers LLM and the inter-wide-area location information management servers NLM. Then, these control devices (controllers) including the wireless LAN controllers WLAN-CNT share functions as follows. To be specific, each wireless LAN controller WLAN-CNT manages home location information and visited location information of the mobile terminal MT. Each of the in-area location information management servers LLM manages detailed location information of the mobile terminal MT. Further, the inter-wide-area location information management server NLM has a feature of managing rough location information of the mobile terminal MT.

Configurations of the wireless LAN controller WLAN-CNT, the in-area location information management server LLM and the inter-wide-area location information management server NLM, which serve to manage the location information of the mobile terminal MT, are as illustrated in FIGS. 3 and 4.

Further, structures of the location information management tables 4, 25 in the wireless LAN controller WLAN-CNT, the in-area location information management server LLM and the inter-wide-area location information management server NLM, are as shown in FIGS. 5, 6 and 7.

The communication network system SYS in the third embodiment has a further feature that follows. In this communication network system SYS, with respect to application software (Application) using the location information for emergency call services such as Dial 110 and Dial 119, a repose is given by querying the in-area location information management server LLM and the wireless LAN controller WLAN-CNT about the present location information of the mobile terminal MT utilized by the user via the inter-wide-area location information management server NLM.

### Operational Example of Communication Network System

Next, an operational example of the communication network system SYS in the third embodiment of The present invention shown in FIG. 18, will be explained with reference to relational diagrams. Note that circled numerals represent procedure numbers of the processes throughout the drawings for illustrating the operational example.

Process 1: Query about Location Information

In the case of the use employing an IM (Instant Message) or under presence management, location information application (Application) PAP installed into the terminal queries a location information application server PSV about the location information. It should be noted that without being limited to the location information query message disclosed in the third embodiment, the general protocols such as XML/SOAP (Extensible Markup Language/Simple Object Access Protocol) and SIP/SIMPLE (Session Initiation Protocol/SIP for Instant Messaging and Presence Leveraging Extensions) are usable. Further, the query about the location information is made by using a MAC address of the communication partner mobile terminal MT or a user ID.

Process 2: Query about Location Information

The location information application server PSV, in response to the query from the location information application PAP of the terminal, sends the location information query message to the inter-wide-area location information management server NLM accommodated in the carrier relay IP network W-IP-NW.

Process 3: Query about Location Information

The inter-wide-area location information management server NLM, in response to the query from the location information application server PSV, sends the location information query message to the in-area location information management server LLM (#1) accommodated in the carrier area IP network R-IP-NW (#1).

In the inter-wide-area location information management server NLM, the location information processing unit 23 receives the query from the location information application server PSV via the 10/100 Base-TX PHY/MAC 21 and the Operating System/TCP/IP processing unit 22. The location information processing unit 23 judges that this message is a query about an AP address of the connecting destination to which the terminal MT connects, and further transfers, without changing the contents of the received message, the query message to the in-area location information management server LLM (#1) via the Operating System/TCP/IP processing unit 22 and the 10/100 Base-TX PHY/MAC 21.

Process 4: Query about Location Information

In the in-area location information management server LLM (#1), in response to the query from the inter-wide-area location information management server NLM, the location information query message is sent to the wireless LAN controller WLAN-CNT (#1) of the wireless LAN system WLAN.

In the in-area location information management server LLM, the location information processing unit 23 receives the query from the location information application server PSV via the 10/100 Base-TX PHY/MAC 21 and the Operating System/TCP/IP processing unit 22. The location information processing unit 23 judges that this query is a query about the AP address of the connecting destination to which the terminal MT connects, and further transfers, without changing the contents of the received message, the query message to the wireless LAN controller WLAN-CNT (#1) via the Operating System/TCP/IP processing unit 22 and the 10/100 Base-TX PHY/MAC 21.

Process 5: Location Information Response

In the wireless LAN controller WLAN-CNT (#1), responding to the query from the in-area location information management server LLM (#1), the IP address of the connecting destination access point AP is sent back as a response.

Namely, in the wireless LAN controller WLAN-CNT, after the 10/100 Base-TX PHY/MAC 1 has received the location information query message from the in-area location information management server LLM, this message is transferred to the Operating System/TCP/IP processing unit 2. The Operating System/TCP/IP processing unit 2 judges that this message is a location information related packet, and transfers this packet to the location information processing unit 3.

The location information processing unit 3 judges that this packet is a query about the location information, and searches the location information DB 4 for an IP address of the connecting destination access point AP by employing the user ID as a search key. The location information processing unit 3 sends a search result as a location information response message to the in-area location information management server LLM. On this occasion, the location information processing unit 3 transfers the location information response message to the TCP/IP processing unit 2, and further transmits the message to the in-area location information management server LLM via the 10/100 Base-TX PHY/MAC 1.

Process 6: Location Information Response

Through the process 5, the in-area location information management server LLM receives the location information response message from the wireless LAN controller WLAN-CNT and transfers this message to the inter-wide-area location information management server NLM.

Hereat, in the in-area location information management server LLM, the location information processing unit 23 receives the location information response message via the 10/100 Base-TX PHY/MAC 21 and the Operating System/TCP/IP processing unit 22. The location information processing unit 23 gives a response, without changing the contents of the received message, to the inter-wide-area location information management server NLM making the query via the Operating System/TCP/IP processing unit 22 and the 10/100 Base-TX PHY/MAC 21.

Process 7: Location Information Response

Through the process 6, the inter-wide-area location information management server NLM receives the location information response message from the in-area location information management server LLM, and transfers this message to the location information application server PSV.

At this time, in the inter-wide-area location information management server NLM, the location information processing unit 23 receives the message via the 10/100 Base-TX PHY/MAC 21 and the Operating System/TCP/IP processing unit 22.

The location information processing unit 23 gives a response, without changing the contents of the received message, to the location information application server PSV making the query via the Operating System/TCP/IP processing unit 22 and the 10/100 Base-TX PHY/MAC 21.

Process 8: Location Information Response

Through the process 7, the location information application server PSV receives the location information response message from the inter-wide-area location information management server NLM, and converts, depending on a type of the location information application PAP, the IP address of the connecting destination access point AP into an address and latitude/longitude information or actual geographical data of an on-map area etc, thereby sending the converted information or data as a response to the location information application PAP of the terminal.

### Effect of Third Embodiment

In the communication network system SYS in the third embodiment, the location information is managed in a way that adds the geographical information to the access point AP, thereby enabling the functional addition to the existing location information providing service such as the location information response in the emergency call services like Dial 110 and Dial 119, the IP telephony, the presence management and the IM (Instant Message).

### Modified Example

The communication network system in each of the embodiment discussed above can be applied to WiMAX (Worldwide Interoperability for Microwave Access) defined as a technology based on the premise of wireless transmission and other wireless technologies as well as to the wireless LAN.

The processes in the respective embodiments discussed above are provided by way of a program executable by a computer, and can be provided through a recording medium such as a CD-ROM and a flexible disc and further via the communication line.

Moreover, the respective processes in the respective embodiments discussed above can be executed in a way that selects and combines an arbitrary plurality of the processes or all those processes.

What is claimed is:

1. A large-scale wide area network system having a location information management function for enabling a mobile terminal to move between wireless zones, comprising:
a plurality of wireless communication base devices respectively configuring a plurality of access points covering the wireless zones subordinate thereto;
a plurality of wireless communication base control devices performing integrated control of the plurality of corresponding wireless communication base devices, and managing IP addresses of the wireless communication base control devices of a home location and a visited location as location information of the mobile terminal;
a plurality of in-area location information management devices respectively connected to the plurality of corresponding wireless communication base control devices via respective area IP networks corresponding to areas administered by the same common carrier, and managing the IP address of the wireless communication base control device of the home location as the location information of the mobile terminal; and
a wide area location information management device hierarchically connected to the plurality of in-area location information management devices via a wide area IP network corresponding to a wide area administered by the common carrier, and managing the IP address of the corresponding in-area location information management device as the location information of the mobile terminal.

2. A large-scale wide area network system according to claim 1, further comprising a response device sending back, as a response, only existing-in-zone information showing that the mobile terminal exists in a zone under control of a self common carrier IP network administered by the self common carrier in response to a query about the location information of the mobile terminal from one other common carrier if necessary for linking up, about the location information of the mobile terminal, with the other common carrier IP network administered by the other common carrier different from the self common carrier.

3. A large-scale wide area network system according to claim 1, further comprising a response device sending back, in response to a query about the location information from an application utilizing the location information of the mobile terminal, the location information of the mobile terminal as a response that has been acquired by the wireless communication base control device, the in-area location information management device and the wide area location information management device in linkage with each other.

4. A large-scale wide area network system according to claim 1, wherein each of the plurality of wireless communication base devices manages a terminal MAC address and a terminal IP address as the location information of the mobile terminal.

5. A large-scale wide area network system according to claim 1, wherein each of the plurality of wireless communication base control devices further manages a terminal MAC address, a terminal IP address and an IP address of the wireless communication base device covering the present location as the location information of the mobile terminal.

6. A large-scale wide area network system according to claim 1, wherein each of the plurality of in-area location information management devices further manages a terminal MAC address and a terminal IP address as the location information of the mobile terminal.

7. A large-scale wide area network system according to claim 1, wherein the wide area location information management device further manages a terminal MAC address as the location information of the mobile terminal.
